(19) United States
(12) Patent Application Publication
(10) Pub. No.: US 2014/0308930 A1
(43) Pub. Date: Oct. 16, 2014

(54) TIMELY, GLANCEABLE INFORMATION ON A WEARABLE DEVICE

(71) Applicant: Bao Tran, (US)

(72) Inventor: Bao Tran, Saratoga, CA (US)

(73) Assignee: Bao Tran, Saratoga, CA (US)

(21) Appl. No.: 13/862,249

(22) Filed: Apr. 12, 2013

(51) Int. Cl. H04W 4/00; H04W 4/18

(52) U.S. Cl. CPC H04W 4/001; H04W 4/18
USPC 455/414.1

(57) ABSTRACT

Systems and methods are disclosed for receiving and interacting with downloadable glanceable content on a mobile device.

### BACKGROUND

Mobile electronic devices, such as cell devices, wireless PDAs, wireless laptops and other mobile communication devices are making impressive inroads with consumers. Many of the mobile electronic devices are able to perform a variety of tasks and include a user interface to help the user access the features associated with the device. For example, some mobile devices include a display unit that displays graphical data to support email, instant messaging, web browsing, and other non-voice features. Using their mobile devices, users access the Internet, send and receive email, participate in instant messaging, and perform other operations. Accessing the desired information and customizing their devices, however, may be cumbersome for the user.

United States patent application 20050278757, the content of which is incorporated herewith, discloses downloading contents such as news, weather, traffic, trivia, and watch faces to a watch. The contents are broadcast to mobile devices using a commercial service known as MSN Direct. Microsoft, along with its partners in the FM broadcasting industry, has created the Direct Band Network which is a continuous broadcast network across the US and Canada. Using FM radio sub-carrier frequencies, watches with MSN Direct are continuously updated with information wherever coverage exists for the FM network. However, this system is unidirectional.

### SUMMARY

In one aspect, systems and methods are disclosed for receiving and interacting with downloadable content on a mobile device by receiving a plurality of contents through at least one of the following: a broadcast directed to one or more devices; a direct connection; and a peer connection from another device; and periodically cycling through the received contents and displaying each content for a predetermined period on a display of the device.

In another aspect, a system to receive and interact with downloadable content on a mobile device includes a broadcast device configured to broadcast contents to a plurality of mobile electronic devices at the same time and a mobile device to receive contents through at least one of the following: a broadcast directed to one or more devices; a direct connection; and a peer connection from another device, said device periodically cycling through the received contents and displaying each content for a predetermined period on a display of the device.

Implementations of the above aspect may include one or more of the following. The system can receive a sports channel, a device skin channel, a weather channel, a stocks channel, a news channel, a traffic channel, a movies channel, a secured channel, or a search channel. The device skin channel selection can include selecting a device face from a plurality of device faces. The device can receive an input from a button (such as a keypad or an up/down button) on the device indicating the channel to be selected. The contents can be transmitted using SMS protocol, Internet protocol, or encrypted protocol. The device periodically updates the contents with fresh information. The system allows a user to search information using a search engine. The system can run a predetermined search query on a periodic basis and transmitting a search result over the search channel. The secured channel can include a bank summary, a credit card summary, or a brokerage financial summary, where a user is authenticated prior to displaying the secured channel content.

The broadcast device can be configured to broadcast a Bluetooth signal in a personal area network, an FM communication signal, a VHF communication signal, an UHF communication signal, a terrestrial broadcast communication signal, or a digital video broadcast (DVB) communication signal.

The broadcast device or a server can be configured to receive input from a user to select content to be broadcast. The broadcast device can send a configuration message to the mobile electronic device indicating what watch faces to keep on the mobile electronic device.

Information communicated by the system include real-time stock quotes, stock trading, weather updates, traffic alerts, sports scores, flight confirmation, news flashes, currency conversion, online yellow pages, games, mobile banking, mobile stock trading and other location-based, time-sensitive information.

Advantages of the system may include one or more of the following. The system uses standard, non-proprietary networks to transmit timely and relevant Web-based information. The system enables mobile devices to provide timely, glanceable information conveniently available on a mobile device. The system offers people a way of staying connected to important information such as news, weather, sports, stocks, and more as well personal messages and appointment reminders. The service delivers tailored services specific to the user's interests and location and discreetly delivers instant personal messages. A subtle vibration or quick glance at the screen alerts the user to a received message. Downloadable device skins/faces complement the user's personal style and mood.

The system brings enhanced functionality to mobile devices and combines personal style and personalized information together into a single accessory. People can choose the style of their devices, change the device skin/face depending on their mood or environment and be both entertained and informed. Personalized information is delivered in a discrete and glanceable manner.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE FIGURES

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, various examples discussed in the present document.

FIG. 1 shows an exemplary system in which present invention is implemented, according to embodiments as disclosed herein;

FIG. 2 shows an exemplary network for medication compliance data transmission by the system of FIG. 1, according to embodiments as disclosed herein;

FIG. 3 shows an exemplary process for receiving and interacting with downloadable content on a mobile device, according to embodiments as disclosed herein;

FIG. 4 shows an exemplary process to set up and operate the system of FIG. 1 to provide glanceable information to a user, according to embodiments as disclosed herein;

FIG. 5A shows an exemplary method for receiving and interacting with content using a watch, according to embodiments as disclosed herein;

FIG. 5B shows various exemplary glanceable screens shown on the mobile device, according to embodiments as disclosed herein;

FIG. 6 shows an exemplary process to monitor a patient and display on the mobile device, according to embodiments as disclosed herein;

FIG. 7 shows a portable embodiment of the present invention where the voice recognizer is housed in a wrist-watch, according to embodiments as disclosed herein;

FIG. 8 shows an exemplary network working with the wearable appliance of FIG. 7, according to embodiments as disclosed herein; and

FIG. 9 is a flow chart illustrates generally, a method for receiving and interacting with content using a watch, according to embodiments as disclosed herein;

FIG. 10 is a flow chart illustrates generally, a method 1000 for receiving and interacting from various sources using a watch, according to embodiments as disclosed herein; and

FIG. 11 is a flow chart illustrates generally, a method for payment processing using NFC secure payment method, according to embodiments as disclosed herein;

FIG. 12 is a flow chart illustrates generally, a method for presenting user information based on appointment data, according to embodiments as disclosed herein; and

FIG. 13 is a flow chart illustrates generally, a method for automatically presenting information about person with whom the user is interacting, according to embodiments as disclosed herein.

### DETAILED DESCRIPTION

The various embodiments will be described more fully hereinafter with reference to the accompanying drawings, in which some, but not all embodiments of the invention are shown. Indeed, these systems may be embodied in many different forms and should not be construed as limited to the embodiments set forth herein; rather, these embodiments are provided so that this disclosure will satisfy applicable legal requirements. Like numbers refer to like elements throughout.

The embodiments herein disclose apparatus, system, and method related to downloadable content for mobile devices such as cell devices. Content may be selected and viewed on a display of the device by means of passive interaction (e.g., hands free operation) or active interaction (e.g., selecting buttons). The systems and methods includes receiving and interacting with downloadable content on a mobile device by receiving a plurality of contents through at least one of the following: a broadcast directed to one or more devices; a direct connection; and a peer connection from another device; and periodically cycling through the received contents and displaying each content for a predetermined period on a display of the device. Further, the proposed system and method can be readily implemented on the existing infrastructure and may not require extensive set-up or instrumentation.

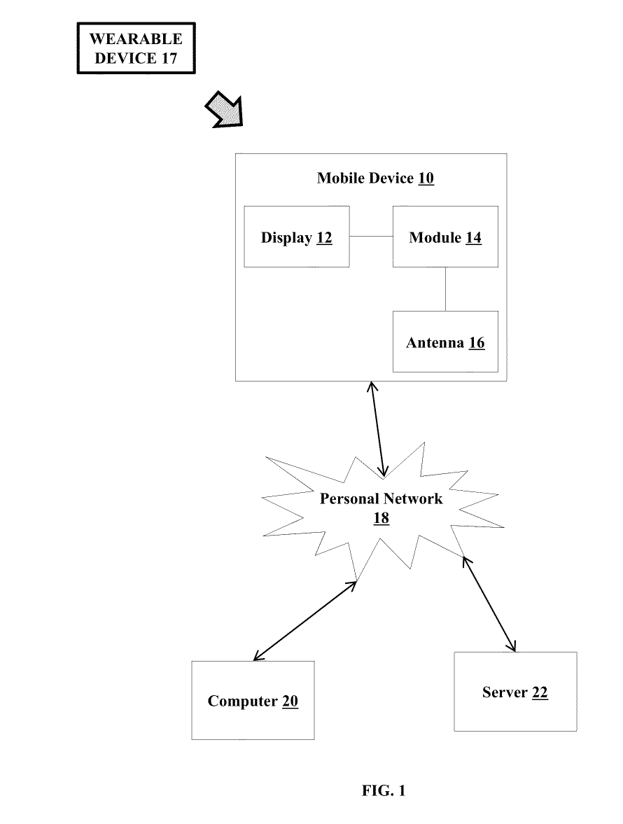

Referring now to the drawings, and more particularly to FIGS. 1 through 10, where similar reference characters denote corresponding features consistently throughout the figures, there are shown embodiments.

FIG. 1 shows an exemplary system that provides glanceable information to a user. The system includes a wearable device 17 that may be a watch, an armband, a pendant, a key chain, or a patch, for example. The wearable device 17 communicates with a smart phone device 10 using a low power protocol such as low power Bluetooth 4.0 protocol or a low power WiFi protocol, for example. The device 10 includes a display 12 that is driven by a module 14 that includes a processor, memory, and a personal area network transceiver. The module 14 is connected to an antenna 16 to provide radio frequency signals to the transceiver. The module 14 is also connected to one or more input devices 18 such as buttons, among others.

The wearable device 17 provides glanceable information to a user. Glanceable information is formatted such that a user can glance at the information on the display of the electronic device without requiring further navigation. One example of glanceable information is a stock quote, where the glanceable information is the call letters and the stock values. Another example of glanceable information is the current weather conditions in a designated region or city, where the glanceable information is the city/region name. Still another example of glanceable information is a brief headline of news. Further examples of glanceable information are within the scope of the present invention. Glanceable information is particularly useful in devices that have limited viewing areas such as a watch-type device, a cellular telephone, and the like.

In one embodiment, the mobile phone 10 includes flash memory that stores Palm OS or Windows CE OS which is executed by a Motorola Dragon ball Super VZ processor or an ARM processor. In one implementation, a stylus resides within the watch buckle for Graffiti and other types of input on a 160×160 pixel resolution grayscale with backlight touch screen. The system can provide one-handed navigation through a 3-way Rocker switch and Back button, the ability to beam data to another device via the Infrared Port, USB HotSync support for Mac OS and Windows, and a lithium-ion rechargeable battery. In another embodiment, the system can be SPOT compatible through an FM radio receiver to push and display up-to-date personalized and location-specific information with the MSN Direct service available from Microsoft that provide channels such as news, weather information, stock quotes, personal messages, and calendar appointment reminders.

The mobile device 10 communicates over a personal area network 18 to a computer 20. The computer 20 in turn is connected to a wide area network (WAN) such as the Internet where the computer 20 can receive content from the Internet. A server 22 can collect the data on behalf of the user preferences and interests and send to the computer 20. For example, the computer 20 can retrieve Really Simple Syndication (RSS) data feeds and transmit the data feeds to the mobile device 10 over the personal area wireless network 18.

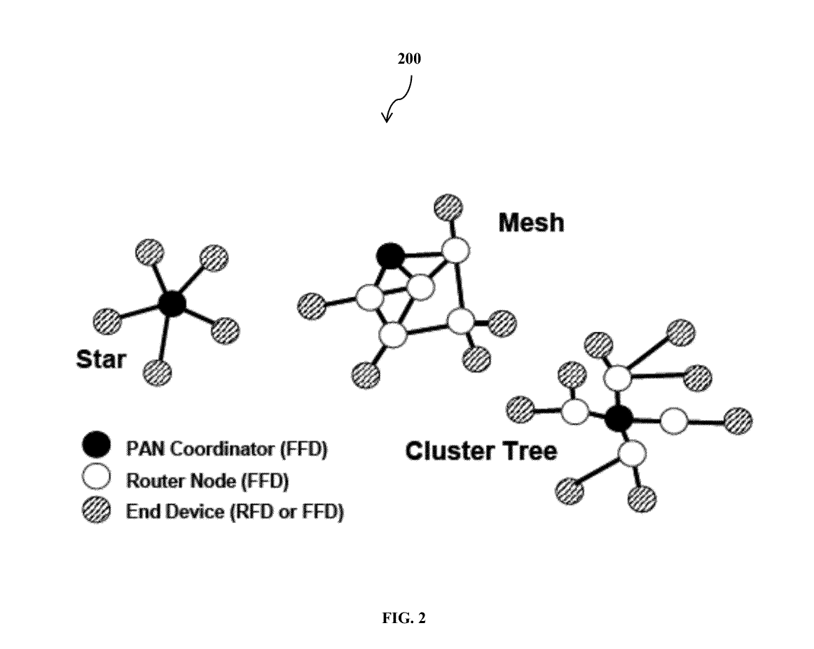

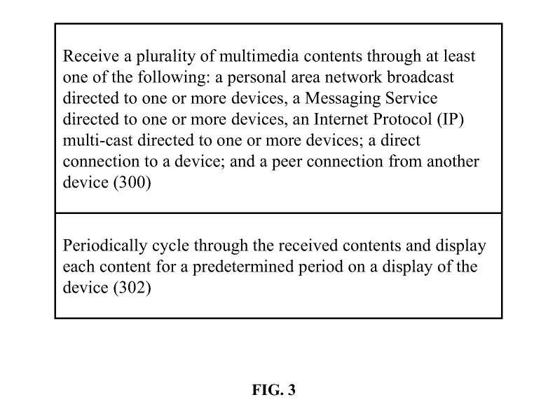

FIG. 2 shows an exemplary personal area network for medication compliance data transmission by the system of FIG. 1. In an embodiment, the personal area network is an IEEE 802.15.4 network or Bluetooth. IEEE 802.15.4 defines An FFD can talk to RFDs or other FFDs, while an RFD can talk only to an FFD. An RFD is intended for applications that are extremely simple, such as a light switch or a passive infrared sensor; they do not have the need to send large amounts of data and may only associate with a single FFD at a time. Consequently, the RFD can be implemented using minimal resources and memory capacity and have lower cost than an FFD. An FFD can be used to implement all three Logical Device types, while an RFD can take the role as an End Device. In other embodiments, Bluetooth transmitters, cellular transmitters, Wi-Fi transmitters, or WiMAX transmitters can be used.

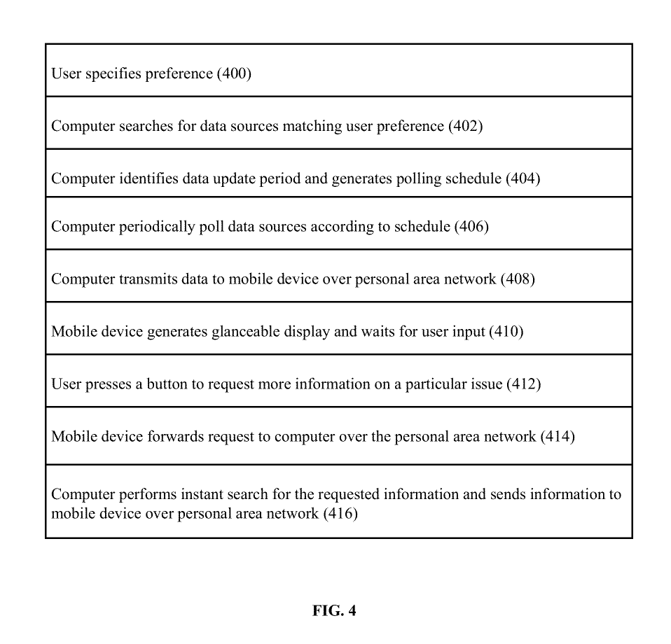

FIG. 3 shows an exemplary process for receiving and interacting with downloadable content on the mobile device 10, according to embodiments as disclosed herein. The process includes receiving multimedia contents through a personal area network broadcast directed to one or more devices (300). The system receives a plurality of multimedia contents through at least one of the following: the personal area network broadcast directed to one or more devices, a Messaging Service directed to one or more devices, an Internet Protocol (IP) multi-cast directed to one or more devices; a direct connection to a device; and a peer connection from another device. Further, the process includes periodically cycling through the received contents and displaying the content for a predetermined period on the device (302).

FIG. 4 shows an exemplary process to set up and operate the system of FIG. 1 to provide glanceable information to a user, according to embodiments as disclosed herein. First, the user specifies preferences for information to be displayed (400). The preferences or interests can be specified to the computer 20 or a remote server. The computer or a remote server searches for data sources matching user preference (402). The search can be done using a search engine, or alternatively to a known database of content providers. The computer or server identifies data update period and generates polling schedule (404). The computer periodically polls data sources according to schedule (406). The retrieved data is transmitted to the mobile device over the personal area network (408). The mobile device generates glanceable display and waits for user input (410). The user presses a button to request more information on a particular issue (412), and the mobile device forwards request to computer over the personal area network (414). The computer performs an instant search for the requested information and sends information to mobile device over personal area network (416).

The system brings enhanced functionality to mobile devices and combines personal style and personalized information together into a single accessory. People can choose the style of their devices, change the device skin/face depending on their mood or environment and be both entertained and informed. Personalized information is delivered in a discrete and glanceable manner.

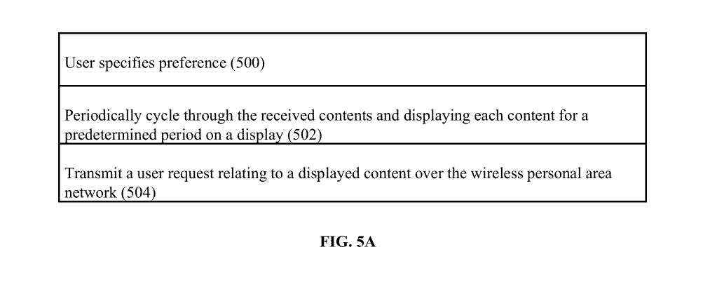

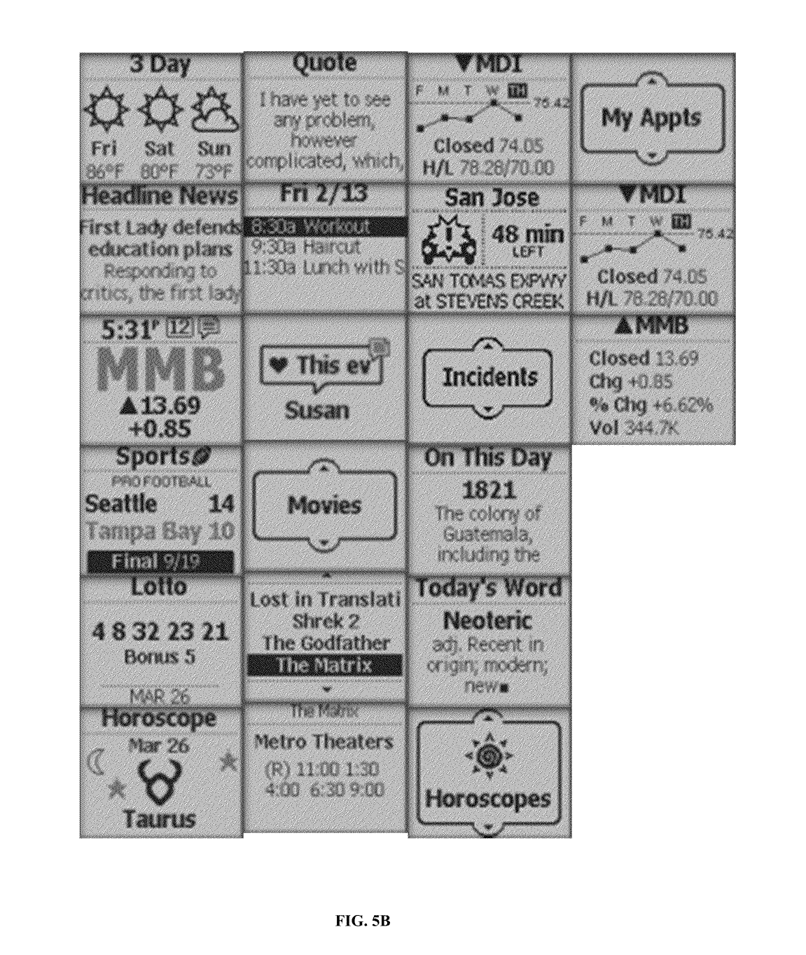

FIG. 5A shows an exemplary method for receiving and interacting with content using a watch, according to embodiments as disclosed herein. The watch receives multimedia contents through a wireless personal area network (500). The watch periodically cycles through the received contents and displaying the content for a predetermined period on a display (502). The watch transmits a user request relating to a displayed content over the wireless personal area network (504).

In one embodiment, the system can receive a sports channel, a device skin (or device face) channel, a weather channel, a stocks channel, a news channel, a traffic channel, a movies channel, a secured channel, or a search channel. The device skin channel selection can include selecting a device face from a plurality of device faces. The device can receive an input from a button (such as a keypad, scrolling key, or an up/down button) on the device indicating the channel to be selected. The contents can be transmitted using Bluetooth or alternatively through SMS protocol, Internet protocol, or encrypted protocol. The device periodically updates the contents with fresh information. The system allows a user to search information using a search engine. The system can run a predetermined search query on a periodic basis and transmitting a search result over the search channel. The secured channel can include a bank summary, a credit card summary, or a brokerage financial summary, where a user is authenticated prior to displaying the secured channel content. The user can specify the device to scroll text associated with one channel. Alternatively, a predetermined set of channels or all channels can be rotated for display at the user's selection. Data can be pushed to the device or alternatively the device can pull its specific data needs from a server. The pull implementation can send a series of query requests to the server over the personal area network protocol.

In another embodiment, the system can look for particular interests on behalf of the user. For example, the system can poll the on-line trading company eBay and update the bidding results to the user through the watch. The periodicity of the polling can be adjustable. In the eBay embodiment, the system can poll on a daily basis until the day of the bidding deadline. On that day, the polling can be changed to an hourly polling until the last 10 minutes, where the polling can be done on a minute by minute basis.

The content is sent through the Bluetooth protocol, but alternatively can be sent using SMS, MMS or IP multicast protocols. The direct connection can be done by email, serial port, USB port, wireless USB port, Fire-wire port, or over a wireless connection using Bluetooth or infrared. In the described embodiments, the electronic devices may be mobile devices, such as smart devices, PDAs, watches, among others, that are configured to receive and transmit communication signals over a personal area radio network. Alternatively, the electronic devices may be configured to receive broadcast transmissions from one or more broadcast towers and are capable of receiving and processing messages from the broadcast transmissions. After information is received and processed by the client device, a user may passively or actively review the information that is stored in the electronic device.

The term “content” can be any information that may be stored in an electronic device. By way of example, and not limitation, content may comprise graphical information, textual information, and any combination of graphical, textual information, audio or video information. Content may be displayable information or auditory information. Auditory information may comprise a single sound or a stream of sounds.

Another exemplary system to receive and interact with downloadable content on a mobile device includes a broadcast device configured to broadcast contents to a plurality of mobile electronic devices at the same time and a mobile device to receive contents through at least one of the following: a personal area network broadcast directed to one or more devices; a direct connection; and a peer connection from another device, said device periodically cycling through the received contents and displaying each content for a predetermined period on a display of the device.

The periodic cycling of content allows the user to scan information in a glanceable manner without pressing any device buttons. The user can set the device to display information relating to one channel. Alternatively, a glance option scrolls continuously through all channels selected by the user. At any time, the user can press a button to enter a particular channel to view the full details of that channel. For example, when the Headlines screen is scrolling by, the user can press a button to bring up all text associated with a particular headline. The information may be shown along with an advertisement. The advertisement can be a line of scrolling text displaying a logo or a trade name or trademark, among others.

The system uses standard, non-proprietary networks to transmit timely and personally relevant information to any digital device. The system enables mobile devices to provide timely, glanceable information conveniently available. The system offers people a way of staying connected to important information such as news, weather, sports, stocks, and more as well personal messages and appointment reminders. The service delivers tailored services specific to the user's interests and location and discreetly delivers instant personal messages. A subtle vibration or quick glance at the screen alerts the user to a received message. Downloadable device skins/faces complement the user's personal style and mood.

FIG. 5B shows various exemplary glanceable screens shown on the wearable device, according to watch-based embodiments as disclosed herein. Services provided by the system include real-time stock quotes, stock trading, weather updates, traffic alerts, sports scores, flight confirmation, news flashes, currency conversion, online yellow pages, games, mobile banking, mobile stock trading and other location-based, time-sensitive information.

The mobile device 10 includes a series of buttons or scrollable keypads which are arranged to operate as part of a user interface (UI). Each button may have a default function and/or a context determined function. The currently selected channel determines the context for each button. Alternatively, the currently active display may determine the context for each button. For example, a display screen (e.g., a help screen) may be superimposed on the main display such that the display screen becomes the active context. The device is context sensitive in that the function that is associated with each button may change based on the selected channel or display screen. For example, button “A” has a default function of page up or previous page in the currently selected channel. Button “A” may also have an alternate function based on the currently selected channel or display. For example, button “A” may be configured to activate a speed list browse function after button “A” is activated for a predetermined time interval. In the speed list browse function, a pop-up visual cue (e.g., a pop-up window) may be used to indicate how that list is indexed. Button “B” has a default function of page down or next page in the currently selected channel. The button “B” may also have an alternate function based on the currently selected channel or display. In one example, button “B” is activated for a predetermined time interval (e.g., two seconds) to select a “speed list browse” function. Button “C” has a default function of next channel. The button “C” may also have an alternate function based on the currently selected channel or display. In one example, button “C” is activated for a predetermined time interval (e.g., two seconds) to select the main channel or “primary” channel. The main channel in an example device can be a news channel that provides the user with fresh news and information. However, devices may be configured to have some other display screen that is recognized by the device as a “primary” channel or “home” location. Button “D” has a default (or “primary”) function of “enter.” The “enter” function is context sensitive and used to select the “enter” function within a selected channel, or to select an item from a selection list. The button “D” may also have an alternate function based on the currently selected channel or display. For example, the “D” button is activated for a predetermined time interval (e.g., two seconds) to activate a delete function. In another example, the “D” button may be selected for a predetermined time to activate a help screen or an additional set mode. In this example, the help screen remains active while button “D” is activated, and the help screen is deactivated (e.g., removed from the display) when the “D” button is released. The buttons are arranged such that the electronic device accomplishes navigating and selecting content on each channel in a simple manner. An optional fifth button (e.g., button “E”) may be arranged to provide other functions such as backlighting or another desired function. Other buttons may also be included.

The user may customize his/her channels through a user web site on the server 22 or by setting options directly on the device. Using the website, the user may set options and select information associated with channels to which the user has subscribed. Channel information and various options may also be automatically retrieved from a web site to which the user participates in. For example, the web site may be the user's log-in home page in which the user has already selected various options customizing the page. These options may be used to populate the options associated with various channels. For example, a user's selected cities may be used in a weather channel, the user's selected theaters may be used in a movies channel, the user's selected stocks they desire to track may be used in a stock channel, the user's favorite search keywords may be used in the search channel, the user's favorite shops or restaurants or pubs may be used in the stores channel, and the like.

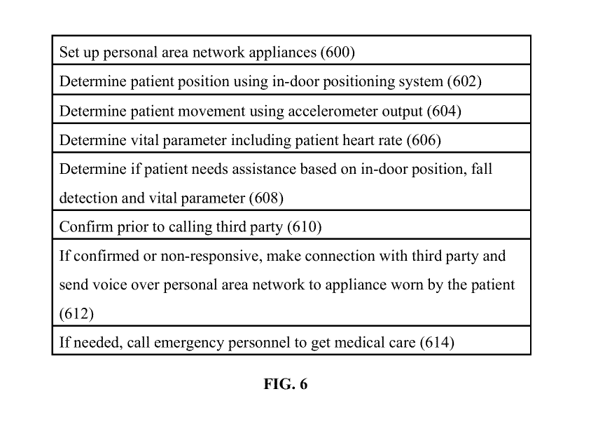

FIG. 6 shows an exemplary process to monitor a patient (or any other user) and display on the mobile device, according to embodiments as disclosed herein. First, the process sets up personal area network appliances (600). Next, the process determines patient position using in-door positioning system (602). The process then determines patient movement using accelerometer output (604). Sharp accelerations may be used to indicate fall. Further, the z axis accelerometer changes can indicate the height of the appliance from the floor and if the height is near zero, the system infers that the patient had fallen. The system can also determine vital parameter including patient heart rate (606). The system determines if patient needs assistance based on in-door position, fall detection and vital parameter (608). If a fall is suspected, the system confirms the fall by communicating with the patient prior to calling a third party such as the patient's physician, nurse, family member, or a paid call center to get assistance for the patient (610). If confirmed or if the patient is non-responsive, the system contacts the third party and sends voice over personal area network to appliance on the patient to allow one or more third parties to talk with the patient (612). If needed, the system calls and/or conferences emergency personnel into the call (614).

In one embodiment, if the patient is outside of the personal area network range such as when the user is traveling away from his/her home, the system continuously records information into memory until the home personal area network is reached or until the monitoring appliance reaches an internet access point. While the wearable appliance is outside of the personal area network range, the device searches for a cell phone with an expansion card plugged into a cell phone expansion slot such as the SDIO slot. If the wearable appliance detects a cell phone that is personal area network compatible, the wearable appliance communicates with the cell phone and provides information to the server 200 using the cellular connection. In one embodiment, a Bluetooth enables device-to-device communications for PDAs and smart phones. In this embodiment, the PDA or cell phone can provide GPS position information instead of the indoor position information generated by the personal area network appliances 8. The cell phone GPS position information, accelerometer information and vital information such as heart rate information is transmitted using the cellular channel to the server 200 for processing as is normal. In another embodiment where the phone works through Wi-Fi (802.11) or WiMAX (802.16) or ultra-wideband protocol instead of the cellular protocol, the wearable appliance can communicate over these protocols using a suitable personal area network interface to the phone. In instances where the wearable appliance is outside of its home base and a dangerous condition such as a fall is detected, the wearable appliance can initiate a distress call to the authorized third party using cellular, Wi-Fi, WiMAX, or UWB protocols as is available.

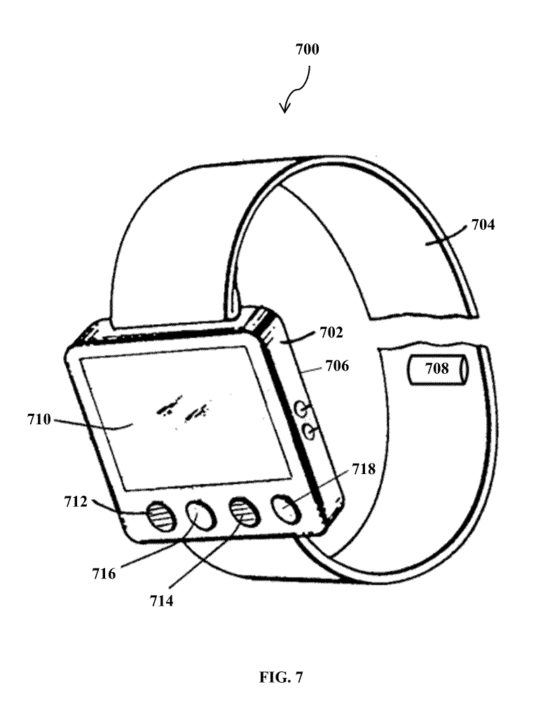

FIG. 7 shows a portable embodiment of the present invention where the voice recognizer is housed in a wrist-watch 700, according to embodiments as disclosed herein. As shown in the FIG. 7, the device includes a wrist-watch sized case 702 supported on a wrist band 704. The case 702 may be of a number of variations of shape but can be conveniently made a rectangular, approaching a box-like configuration. The wrist-band 704 can be an expansion band or a wristwatch strap of plastic, leather or woven material. The processor or CPU of the wearable appliance is connected to a radio frequency (RF) transmitter/receiver (such as a Bluetooth device, a Wi-Fi device, a WiMAX device, or an 802.X transceiver, among others).

In one embodiment, the back of the device is a conductive metal electrode 706 that in conjunction with a second electrode 708 mounted on the wrist band 704, enables differential EKG or ECG to be measured. The electrical signal derived from the electrodes is typically 1 mV peak-peak. In one embodiment where only one electrode 706 or 708 is available, an amplification of about 1000 is necessary to render this signal usable for heart rate detection. In the embodiment with electrodes 706 and 708 available, a differential amplifier is used to take advantage of the identical common mode signals from the EKG contact points; the common mode noise is automatically cancelled out using a matched differential amplifier. In one embodiment, the differential amplifier is a Texas Instruments INA321 instrumentation amplifier that has matched and balanced integrated gain resistors. This device is specified to operate with a minimum of 2.7V single rail power supply. The INA321 provides a fixed amplification of 5× for the EKG signal. With its CMRR specification of 94 dB extended up to 3 KHz the INA321 rejects the common mode noise signals including the line frequency and its harmonics. The quiescent current of the INA321 is 40 mA and the shut down mode current is less than 1 mA. The amplified EKG signal is internally fed to the on chip analog to digital converter. The ADC samples the EKG signal with a sampling frequency of 512 Hz. Precise sampling period is achieved by triggering the ADC conversions with a timer that is clocked from a 32.768 kHz low frequency crystal oscillator. The sampled EKG waveform contains some amount of super imposed line frequency content. This line frequency noise is removed by digitally filtering the samples. In one implementation, a 17-tap low pass FIR filter with pass band upper frequency of 6 Hz and stop band lower frequency of 30 Hz is implemented in this application. The filter coefficients are scaled to compensate the filter attenuation and provide additional gain for the EKG signal at the filter output. This adds up to a total amplification factor of greater than 1000× for the EKG signal.

The wrist band 704 can also contain other electrical devices such as ultrasound transducer, optical transducer or electromagnetic sensors, among others. In one embodiment, the transducer is an ultrasonic transducer that generates and transmits an acoustic wave upon command from the CPU during one period and listens to the echo returns during a subsequent period. In use, the transmitted bursts of sonic energy are scattered by red blood cells flowing through the subject's radial artery, and a portion of the scattered energy is directed back toward the ultrasonic transducer. The time required for the return energy to reach the ultrasonic transducer varies according to the speed of sound in the tissue and according to the depth of the artery. Typical transit times are in the range of 6 to 7 microseconds. The ultrasonic transducer is used to receive the reflected ultrasound energy during the dead times between the successive transmitted bursts. The frequency of the ultrasonic transducer's transmit signal will differ from that of the return signal, because the scattering red blood cells within the radial artery are moving. Thus, the return signal, effectively, is frequency modulated by the blood flow velocity.

A driving and receiving circuit generates electrical pulses which, when applied to the transducer, produce acoustic energy having a frequency on the order of 8 MHz, a pulse width or duration of approximately 8 microseconds, and a pulse repetition interval (PRI) of approximately 16 μs, although other values of frequency, pulse width, and PRI may be used. In one embodiment, the transducer 84 emits an 8 microsecond pulse, which is followed by an 8 microsecond “listen” period, every 16 microseconds. The echoes from these pulses are received by the ultrasonic transducer 84 during the listen period. The ultrasonic transducer can be a ceramic piezoelectric device of the type well known in the art, although other types may be substituted.

An analog signal representative of the Doppler frequency of the echo is received by the transducer and converted to a digital representation by the ADC, and supplied to the CPU for signal processing. Within the CPU, the digitized Doppler frequency is scaled to compute the blood flow velocity within the artery based on the Doppler frequency. Based on the real time the blood flow velocity, the CPU applies the vital model to the corresponding blood flow velocity to produce the estimated blood pressure value.

Prior to operation, calibration is done using a calibration device and the monitoring device to simultaneously collect blood pressure values (systolic, diastolic pressures) and a corresponding blood flow velocity generated by the monitoring device. The calibration device is attached to the base station and measures systolic and diastolic blood pressure using a cuff-based blood pressure monitoring device that includes a motor-controlled pump and data-processing electronics. While the cuff-based blood pressure monitoring device collects patient data, the transducer collects patient data in parallel and through the watch's radio transmitter, blood flow velocity is sent to the base station for generating a computer model that converts the blood flow velocity information into systolic and diastolic blood pressure values and this information is sent wirelessly from the base station to the watch for display and to a remote server if needed. This process is repeated at a later time (e.g., 15 minutes later) to collect a second set of calibration parameters. In one embodiment, the computer model fits the blood flow velocity to the systolic/diastolic values. In another embodiment, the computer trains a neural network or HMM to recognize the systolic and diastolic blood pressure values.

After the computer model has been generated, the system is ready for real-time blood pressure monitoring. In an acoustic embodiment, the transducer directs ultrasound at the patient's artery and subsequently listens to the echo's therefrom. The echoes are used to determine blood flow, which is fed to the computer model to generate the systolic and diastolic pressure values as well as heart rate value. The CPU's output signal is then converted to a form useful to the user such as a digital or analog display, computer data file, or audible indicator. The output signal can drive a speaker to enable an operator to hear a representation of the Doppler signals and thereby to determine when the transducer is located approximately over the radial artery. The output signal can also be wirelessly sent to a base station for subsequent analysis by a physician, nurse, caregiver, or treating professional. The output signal can also be analyzed for medical attention and medical treatment.

It is noted that while the above embodiment utilizes preselected pulse duration of 8 microseconds and pulse repetition interval of 16 microseconds, other acoustic sampling techniques may be used in conjunction with the invention. For example, in a second embodiment of the ultrasonic driver and receiver circuit (not shown), the acoustic pulses are range-gated with a more complex implementation of the gate logic. As is well known in the signal processing arts, range-gating is a technique by which the pulse-to-pulse interval is varied based on the receipt of range information from earlier emitted and reflected pulses. Using this technique, the system may be “tuned” to receive echoes falling within a specific temporal window which is chosen based on the range of the echo-producing entity in relation to the acoustic source. The delay time before the gate is turned on determines the depth of the sample volume. The amount of time the gate is activated establishes the axial length of the sample volume. Thus, as the acoustic source (in this case the ultrasonic transducer) is tuned to the echo-producing entity (red blood cells, or arterial walls), the pulse repetition interval is shortened such that the system may obtain more samples per unit time, thereby increasing its resolution. It will be recognized that other acoustic processing techniques may also be used, all of which are considered to be equivalent.

In one optical embodiment, the transducer can be an optical transducer. The optical transducer can be a light source and a photo-detector embedded in the wrist band portions. The light source can be light-emitting diodes that generate red (λ~630 nm) and infrared (λ~900 nm) radiation, for example. The light source and the photo-detector are slidably adjustable and can be moved along the wrist band to optimize beam transmission and pick up. As the heart pumps blood through the patient's finger, blood cells absorb and transmit varying amounts of the red and infrared radiation depending on how much oxygen binds to the cells' hemoglobin. The photo-detector detects transmission at the predetermined wavelengths, for example red and infrared wavelengths, and provides the detected transmission to a pulse-oximetry circuit embedded within the wrist-watch. The output of the pulse-oximetry circuit is digitized into a time-dependent optical waveform, which is then sent back to the pulse-oximetry circuit and analyzed to determine the user's vital signs.

In the electromagnetic sensor embodiment, the wrist band 704 is a flexible plastic material incorporated with a flexible magnet. The magnet provides a magnetic field, and one or more electrodes similar to electrode 708 are positioned on the wrist band to measure voltage drops which are proportional to the blood velocity. The electromagnetic embodiment may be mounted on the upper arm of the patient, on the ankle or on the neck where peripheral blood vessels pass through and their blood velocity may be measured with minimal interruptions. The flexible magnet produces a pseudo-uniform (non-gradient) magnetic field. The magnetic field can be normal to the blood flow direction when wrist band 704 is mounted on the user's wrist or may be a rotative pseudo-uniform magnetic field so that the magnetic field is in a transversal direction in respect to the blood flow direction. The electrode output signals are processed to obtain a differential measurement enhancing the signal to noise ratio. The flow information is derived based on the periodicity of the signals. The decoded signal is filtered over several periods and then analyzed for changes used to estimate artery and vein blood flow. Systemic stroke volume and cardiac output may be calculated from the peripheral SV index value.

The wrist-band 704 further contains an antenna for transmitting or receiving radio frequency signals. The wristband 704 and the antenna inside the band are mechanically coupled to the top and bottom sides of the wrist-watch housing 702. Further, the antenna is electrically coupled to a radio frequency transmitter and receiver for wireless communications with another computer or another user. Although a wrist-band is disclosed, a number of substitutes may be used, including a belt, a ring holder, a brace, or a bracelet, among other suitable substitutes known to one skilled in the art. The housing 702 contains the processor and associated peripherals to provide the human-machine interface. A display 710 is located on the front section of the housing 702. A speaker 712, a microphone 714, and a plurality of push-button switches 716 and 718 are also located on the front section of housing 702.

The electronic circuitry housed in the watch case 702 detects adverse conditions such as falls or seizures. In one implementation, the circuitry can recognize speech, namely utterances of spoken words by the user, and converting the utterances into digital signals. The circuitry for detecting and processing speech to be sent from the wristwatch to the base station over the personal area network includes a central processing unit (CPU) connected to a ROM/RAM memory via a bus. The CPU is a preferably low power 16-bit or 32-bit microprocessor and the memory is preferably a high density, low-power RAM. The CPU is coupled via the bus to processor wake-up logic, one or more accelerometers to detect sudden movement in a patient, an ADC which receives speech input from the microphone. The ADC converts the analog signal produced by the microphone into a sequence of digital values representing the amplitude of the signal produced by the microphone at a sequence of evenly spaced times. The CPU is also coupled to a digital to analog (D/A) converter, which drives the speaker to communicate with the user. Speech signals from the microphone are first amplified and pass through an antialiasing filter before being sampled. The front-end processing includes an amplifier, a band pass filter to avoid antialiasing, and an analog-to-digital (A/D) converter or a CODEC. To minimize space, the ADC, the DAC and the interface for wireless transceiver and switches may be integrated into one integrated circuit to save space. In one embodiment, the wrist watch acts as a walkie-talkie so that voice is received over the personal area network by the base station and then delivered to a call center over the POTS or PSTN network. In another embodiment, voice is provided to the call center using the Internet through suitable VOIP techniques. In one embodiment, speech recognition such as a speech recognizer is discussed in U.S. Pat. No. 6,070,140 by the inventor of the instant invention, the content of which is incorporated by reference.

In one embodiment, the wireless nodes convert freely available energy inherent in most operating environments into conditioned electrical power. Energy harvesting is defined as the conversion of ambient energy into usable electrical energy. When compared with the energy stored in common storage elements, like batteries and the like, the environment represents a relatively inexhaustible source of energy. Energy harvesters can be based on piezoelectric devices, solar cells or electromagnetic devices that convert mechanical vibrations.

Power generation with piezoelectric can be done with body vibrations or by physical compression (impacting the material and using a rapid deceleration using foot action, for example). The vibration energy harvester consists of three main parts. A piezoelectric transducer (PZT) serves as the energy conversion device, a specialized power converter rectifies the resulting voltage, and a capacitor or battery stores the power. The PZT takes the form of an aluminum cantilever with a piezoelectric patch. The vibration-induced strain in the PZT produces an ac voltage. The system repeatedly charges a battery or capacitor, which then operates the EKG/EMG sensors or other sensors at a relatively low duty cycle. In one embodiment, a vest made of piezoelectric materials can be wrapped around a person's chest to generate power when strained through breathing as breathing increases the circumference of the chest for an average human by about 2.5 to 5 cm. Energy can be constantly harvested because breathing is a constant activity, even when a person is sedate. In another embodiment, piezoelectric materials are placed in between the sole and the insole; therefore as the shoe bends from walking, the materials bend along with it. When the stave is bent, the piezoelectric sheets on the outside surface are pulled into expansion, while those on the inside surface are pushed into contraction due to their differing radii of curvature, producing voltages across the electrodes. In another embodiment, PZT materials from Advanced Cerametrics, Inc., Lambertville, N.J. can be incorporated into flexible, motion sensitive (vibration, compression or flexure), active fiber composite shapes that can be placed in shoes, boots, and clothing or any location where there is a source of waste energy or mechanical force. These flexible composites generate power from the scavenged energy and harness it using microprocessor controls developed specifically for this purpose. Advanced Cerametric's viscose suspension spinning process (VSSP) can produce fibers ranging in diameter from 10 μm ( 1/50 of a human hair) to 250 μm and mechanical to electrical transduction efficiency can reach 70 percent compared with the 16-18 percent common to solar energy conversion. The composite fibers can be molded into user-defined shapes and is flexible and motion-sensitive. In one implementation, energy is harvested by the body motion such as the foot action or vibration of the PZT composites. The energy is converted and stored in a low-leakage charge circuit until a predetermined threshold voltage is reached. Once the threshold is reached, the regulated power is allowed to flow for a sufficient period to power the wireless node such as the Bluetooth CPU/transceiver. The transmission is detected by nearby wireless nodes that are AC-powered and forwarded to the base station for signal processing. Power comes from the vibration of the system being monitored and the unit requires no maintenance, thus reducing life-cycle costs. In one embodiment, the housing of the unit can be PZT composite, thus reducing the weight.

In another embodiment, body energy generation systems include electro active polymers (EAPs) and dielectric elastomers. EAPs are a class of active materials that have a mechanical response to electrical stimulation and produce an electric potential in response to mechanical stimulation. EAPs are divided into two categories, electronic, driven by electric field, and ionic, driven by diffusion of ions. In one embodiment, ionic polymers are used as biological actuators that assist muscles for organs such as the heart and eyes. Since the ionic polymers require a solvent, the hydrated human body provides a natural environment. Polymers are actuated to contract, assisting the heart to pump, or correcting the shape of the eye to improve vision. Another use is as miniature surgical tools that can be inserted inside the body. EAPs can also be used as artificial smooth muscles, one of the original ideas for EAPs. These muscles could be placed in exoskeletal suits for soldiers or prosthetic devices for disabled persons. Along with the energy generation device, ionic polymers can be the energy storage vessel for harvesting energy. The capacitive characteristics of the EAP allow the polymers to be used in place of a standard capacitor bank. With EAP based jacket, when a person moves his/her arms, it will put the electro active material around the elbow in tension to generate power. Dielectric elastomers can support 50-100% area strain and generate power when compressed. Although the material could again be used in a bending arm type application, a shoe type electric generator can be deployed by placing the dielectric elastomers in the sole of a shoe. The constant compressive force provided by the feet while walking would ensure adequate power generation.

For wireless nodes that require more power, electromagnetic, including coils, magnets, and a resonant beam, and micro-generators can be used to produce electricity from readily available foot movement. Typically, a transmitter needs about 30 mW, but the device transmits for only tens of milliseconds, and a capacitor in the circuit can be charged using harvested energy and the capacitor energy drives the wireless transmission, which is the heaviest power requirement. Electromagnetic energy harvesting uses a magnetic field to convert mechanical energy to electrical. A coil attached to the oscillating mass traverses through a magnetic field that is established by a stationary magnet. The coil travels through a varying amount of magnetic flux, inducing a voltage according to Faraday's law. The induced voltage is inherently small and must therefore be increased to viably source energy. Methods to increase the induced voltage include using a transformer, increasing the number of turns of the coil, and/or increasing the permanent magnetic field. Electromagnetic devices use the motion of a magnet relative to a wire coil to generate an electric voltage. A permanent magnet is placed inside a wound coil. As the magnet is moved through the coil it causes a changing magnetic flux. This flux is responsible for generating the voltage which collects on the coil terminals. This voltage can then be supplied to an electrical load. Because an electromagnetic device needs a magnet to be sliding through the coil to produce voltage, energy harvesting through vibrations is an ideal application. In one embodiment, electromagnetic devices are placed inside the heel of a shoe. One implementation uses a sliding magnet-coil design, the other, opposing magnets with one fixed and one free to move inside the coil. If the length of the coil is increased, which increases the turns, the device is able to produce more power.

In an electrostatic (capacitive) embodiment, energy harvesting relies on the changing capacitance of vibration-dependant varactors. A varactor, or variable capacitor, is initially charged and, as its plates separate because of vibrations, mechanical energy is transformed into electrical energy. MEMS variable capacitors are fabricated through relatively mature silicon micro-machining techniques.

In another embodiment, the wireless node can be powered from thermal and/or kinetic energy. Temperature differentials between opposite segments of a conducting material result in heat flow and consequently charge flow, since mobile, high-energy carriers diffuse from high to low concentration regions. Thermopiles consisting of n- and p-type materials electrically joined at the high-temperature junction are therefore constructed, allowing heat flow to carry the dominant charge carriers of each material to the low temperature end, establishing in the process a voltage difference across the base electrodes. The generated voltage and power is proportional to the temperature differential and the Seebeck coefficient of the thermoelectric materials. Body heat from a user's wrist is captured by a thermoelectric element whose output is boosted and used to charge lithium ion rechargeable battery. The unit utilizes the Seeback Effect which describes the voltage created when a temperature difference exists across two different metals. The thermoelectric generator takes body heat and dissipates it to the ambient air, creating electricity in the process.

In another embodiment, the kinetic energy of a person's movement is converted into energy. As a person moves their weight, a small weight inside the wireless node moves like a pendulum and turns a magnet to produce electricity which can be stored in a super-capacitor or a rechargeable lithium battery. Similarly, in a vibration energy embodiment, energy extraction from vibrations is based on the movement of a “spring-mounted” mass relative to its support frame. Mechanical acceleration is produced by vibrations that in turn cause the mass component to move and oscillate (kinetic energy). This relative displacement causes opposing frictional and damping forces to be exerted against the mass, thereby reducing and eventually extinguishing the oscillations. The damping forces literally absorb the kinetic energy of the initial vibration. This energy can be converted into electrical energy via an electric field (electrostatic), magnetic field (electromagnetic), or strain on a piezoelectric material.

In another embodiment, the system extracts energy from the surrounding environment using a small rectenna (microwave-power receivers or ultrasound power receivers) placed in patches or membranes on the skin or alternatively injected underneath the skin.

The rectanna converts the received emitted power back to usable low frequency/dc power. A basic rectanna consists of an antenna, a low pass filter, an ac/dc converter and a dc bypass filter. The rectanna can capture renewable electromagnetic energy available in the radio frequency (RF) bands such as AM radio, FM radio, TV, very high frequency (VHF), ultra high frequency (UHF), global system for mobile communications (GSM), digital cellular systems (DCS) and especially the personal communication system (PCS) bands, and unlicensed ISM bands such as 2.4 GHz and 5.8 GHz bands, among others. The system captures the ubiquitous electromagnetic energy (ambient RF noise and signals) opportunistically present in the environment and transforming that energy into useful electrical power. The energy-harvesting antenna is preferably designed to be a wideband, omni-directional antenna or antenna array that has maximum efficiency at selected bands of frequencies containing the highest energy levels. In a system with an array of antennas, each antenna in the array can be designed to have maximum efficiency at the same or different bands of frequency from one another. The collected RF energy is then converted into usable DC power using a diode-type or other suitable rectifier. This power may be used to drive, for example, an amplifier/filter module connected to a second antenna system that is optimized for a particular frequency and application. One antenna system can act as an energy harvester while the other antenna acts as a signal transmitter/receiver. The antenna circuit elements are formed using standard wafer manufacturing techniques. The antenna output is stepped up and rectified before presented to a trickle charger. The charger can recharge a complete battery by providing a larger potential difference between terminals and more power for charging during a period of time. If battery includes individual micro-battery cells, the trickle charger provides smaller amounts of power to each individual battery cell, with the charging proceeding on a cell by cell basis. Charging of the battery cells continues whenever ambient power is available. As the load depletes cells, depleted cells are switched out with charged cells. The rotation of depleted cells and charged cells continues as required. Energy is banked and managed on a micro-cell basis.

In a solar cell embodiment, photovoltaic cells convert incident light into electrical energy. Each cell consists of a reverse biased pn+ junction, where light interfaces with the heavily doped and narrow n+ region. Photons are absorbed within the depletion region, generating electron-hole pairs. The built-in electric field of the junction immediately separates each pair, accumulating electrons and holes in the n+ and p− regions, respectively, and establishing in the process an open circuit voltage. With a load connected, accumulated electrons travel through the load and recombine with holes at the p-side, generating a photocurrent that is directly proportional to light intensity and independent of cell voltage.

As the energy-harvesting sources supply energy in irregular, random “bursts,” an intermittent charger waits until sufficient energy is accumulated in a specially designed transitional storage such as a capacitor before attempting to transfer it to the storage device, lithium-ion battery, in this case. Moreover, the system must partition its functions into time slices (time-division multiplex), ensuring enough energy is harvested and stored in the battery before engaging in power-sensitive tasks. Energy can be stored using a secondary (rechargeable) battery and/or a super capacitor. The different characteristics of batteries and super capacitors make them suitable for different functions of energy storage. Super capacitors provide the most volumetrically efficient approach to meeting high power pulsed loads. If the energy must be stored for a long time, and released slowly, for example as backup, a battery would be the preferred energy storage device. If the energy must be delivered quickly, as in a pulse for RF communications, but long term storage is not critical, a super capacitor would be sufficient. The system can employ i) a battery (or several batteries), ii) a super capacitor (or super capacitors), or iii) a combination of batteries and super capacitors appropriate for the application of interest. In one embodiment, a micro battery and a micro super capacitor can be used to store energy. Like batteries, super capacitors are electrochemical devices; however, rather than generating a voltage from a chemical reaction, super capacitors store energy by separating charged species in an electrolyte. In one embodiment, a flexible, thin-film, rechargeable battery from Cymbet Corp. of Elk River, Minn. provides 3.6V and can be recharged by a reader. The battery cells can be from 5 to 25 microns thick. The batteries can be recharged with solar energy, or can be recharged by inductive coupling. The tag is put within range of a coil attached to an energy source. The coil “couples” with the antenna on the RFID tag, enabling the tag to draw energy from the magnetic field created by the two coils.

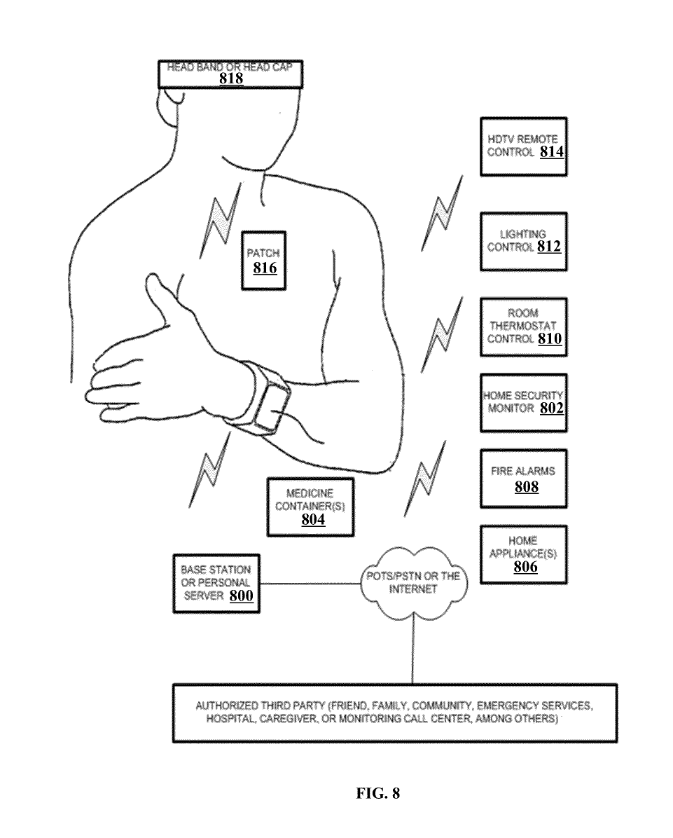

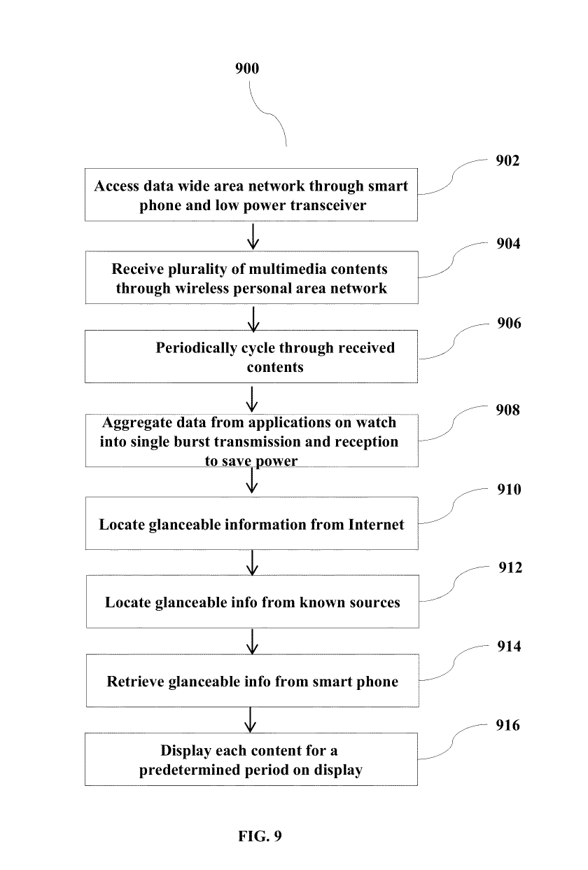

FIG. 8 shows an exemplary personal area network working with the wearable appliance of FIG. 7, according to embodiments as disclosed herein. Data collected and communicated on the display 710 of the watch 700 as well as voice is transmitted to a base station 800 for communicating over a network to an authorized party 802. The watch and the base station is part of a personal area network that may communicate with a medicine cabinet to detect opening or to each medicine container 804 to detect medication compliance. Other devices include personal area network thermometers, scales, or exercise devices. The personal area network also includes a plurality of home/room appliances 806-812. The ability to transmit voice is useful in the case the patient has fallen down and cannot walk to the base station 800 to request help. Hence, in one embodiment, the watch captures voice from the user and transmits the voice over the Bluetooth network to the base station 800. The base station 800 in turn dials out to an authorized third party to allow voice communication and at the same time transmits the collected patient vital parameter data and identifying information so that help can be dispatched quickly, efficiently and error-free. In one embodiment, the base station 800 is a POTS telephone base station connected to the wired phone network. In a second embodiment, the base station 800 can be a cellular telephone connected to a cellular network for voice and data transmission. In a third embodiment, the base station 800 can be a WiMAX or 802.16 standard base stations that can communicate VOIP and data over a wide area network. I one implementation, Bluetooth or 802.15 appliances communicate locally and then transmits to the wide area network (WAN) such as the Internet over Wi-Fi or WiMAX. Alternatively, the base station can communicate with the WAN over POTS and a wireless network such as cellular or WiMAX or both.

One embodiment, the FIG. 8 includes bioelectrical impedance (BI) spectroscopy sensors in addition to or as alternates to EKG sensors and heart sound transducer sensors. BI spectroscopy is based on Ohm's Law: current in a circuit is directly proportional to voltage and inversely proportional to resistance in a DC circuit or impedance in an alternating current (AC) circuit. Bioelectric impedance exchanges electrical energy with the patient body or body segment. The exchanged electrical energy can include alternating current and/or voltage and direct current and/or voltage. The exchanged electrical energy can include alternating currents and/or voltages at one or more frequencies. For example, the alternating currents and/or voltages can be provided at one or more frequencies between 100 Hz and 1 MHz, preferably at one or more frequencies between 5 KHz and 250 KHz. A BI instrument operating at the single frequency of 50 KHz reflects primarily the extra cellular water compartment as a very small current passes through the cell. Because low frequency (<1 KHz) current does not penetrate the cells and that complete penetration occurs only at a very high frequency (>1 MHz), multi-frequency BI or bioelectrical impedance spectroscopy devices can be used to scan a wide range of frequencies.

In a tetra polar implementation, two electrodes on the wrist watch or wrist band are used to apply AC or DC constant current into the body or body segment. The voltage signal from the surface of the body is measured in terms of impedance using the same or an additional two electrodes on the watch or wrist band. In a bipolar implementation, one electrode on the wrist watch or wrist band is used to apply AC or DC constant current into the body or body segment. The voltage signal from the surface of the body is measured in terms of impedance using the same or an alternative electrode on the watch or wrist band. The system of FIG. 8 may include a BI patch 816 that wirelessly communicates BI information with the wrist watch. Other patches 816 can be used to collect other medical information or vital parameter and communicate with the wrist watch or base station or the information could be relayed through each wireless node or appliance to reach a destination appliance such as the base station, for example. The system of FIG. 8 can also include a head-cap 818 that allows a number of EEG probes access to the brain electrical activities, EKG probes to measure cranial EKG activity, as well as BI probes to determine cranial fluid presence indicative of a stroke. As will be discussed below, the EEG probes allow the system to determine cognitive status of the patient to determine whether a stroke had just occurred, the EKG and the BI probes provide information on the stroke to enable timely treatment to minimize loss of functionality to the patient if treatment is delayed.

Bipolar or tetra-polar electrode systems can be used in the BI instruments. Of these, the tetra-polar system provides a uniform current density distribution in the body segment and measures impedance with less electrode interface artifact and impedance errors. In the tetra-polar system, a pair of surface electrodes (I1, I2) is used as current electrodes to introduce a low intensity constant current at high frequency into the body. A pair of electrodes (E1, E2) measures changes accompanying physiological events. Voltage measured across E1-E2 is directly proportional to the segment electrical impedance of the human subject. Circular flat electrodes as well as band type electrodes can be used. In one embodiment, the electrodes are in direct contact with the skin surface. In other embodiments, the voltage measurements may employ one or more contactless, voltage sensitive electrodes such as inductively or capacitively coupled electrodes. The current application and the voltage measurement electrodes in these embodiments can be the same, adjacent to one another, or at significantly different locations. The electrode(s) can apply current levels from 20 uA to 10 mA rms at a frequency range of 20-100 KHz. A constant current source and high input impedance circuit is used in conjunction with the tetra-polar electrode configuration to avoid the contact pressure effects at the electrode-skin interface.

The BI sensor can be a Series Model which assumes that there is one conductive path and that the body consists of a series of resistors. An electrical current, injected at a single frequency, is used to measure whole body impedance (i.e., wrist to ankle) for the purpose of estimating total body water and fat free mass. Alternatively, the BI instrument can be a Parallel BI Model. In this model of impedance, the resistors and capacitors are oriented both in series and in parallel in the human body. Whole body BI can be used to estimate TBW and FFM in healthy subjects or to estimate intracellular water (ICW) and body cell mass (BCM). High-low BI can be used to estimate extracellular water (ECW) and total body water (TBW). Multi-frequency BI can be used to estimate ECW, ICW, and TBW; to monitor changes in the ECW/BCM and ECW/TBW ratios in clinical populations. The instrument can also be a Segmental BI Model and can be used in the evaluation of regional fluid changes and in monitoring extra cellular water in patients with abnormal fluid distribution, such as those undergoing hemodialysis. Segmental BI can be used to measure fluid distribution or regional fluid accumulation in clinical populations. Upper-body and Lower-body BI can be used to estimate percentage BF in healthy subjects with normal hydration status and fluid distribution. The BI sensor can be used to detect acute dehydration, pulmonary edema (caused by mitral stenosis or left ventricular failure or congestive heart failure, among others), or hyper hydration cause by kidney dialysis, for example. In one embodiment, the system determines the impedance of skin and subcutaneous adipose tissue using tetra-polar and bipolar impedance measurements. In the bipolar arrangement the inner electrodes act both as the electrodes that send the current (outer electrodes in the tetra-polar arrangement) and as receiving electrodes. If the outer two electrodes (electrodes sending current) are superimposed onto the inner electrodes (receiving electrodes) then a bipolar BIA arrangement exists with the same electrodes acting as receiving and sending electrodes. The difference in impedance measurements between the tetra-polar and bipolar arrangement reflects the impedance of skin and subcutaneous fat. The difference between the two impedance measurements represents the combined impedance of skin and subcutaneous tissue at one or more sites. The system determines the resistivity's of skin and subcutaneous adipose tissue, and then calculates the skin fold thickness (mainly due to adipose tissue).

Various BI analysis methods can be used in a variety of clinical applications such as to estimate body composition, to determine total body water, to assess compartmentalization of body fluids, to provide cardiac monitoring, measure blood flow, dehydration, blood loss, wound monitoring, ulcer detection and deep vein thrombosis. Other uses for the BI sensor include detecting and/or monitoring hypovolemia, hemorrhage or blood loss. The impedance measurements can be made sequentially over a period of in time; and the system can determine whether the subject is externally or internally bleeding based on a change in measured impedance. The watch can also report temperature, heat flux, vasodilation and blood pressure along with the BI information.

In one embodiment, the BI system monitors cardiac function using impedance cardiography (ICG) technique. ICG provides a single impedance tracing, from which parameters related to the pump function of the heart, such as cardiac output (CO), are estimated. ICG measures the beat-to-beat changes of thoracic bio-impedance via four dual sensors applied on the neck and thorax in order to calculate stroke volume (SV). By using the resistivity p of blood and the length L of the chest, the impedance change AZ and base impedance (Zo) to the volume change ΔV of the tissue under measurement can be derived as follows:

$$Δ V = ρ \frac{{L}^{2}}{{Z}_{0}^{2}} Δ Z$$

In one embodiment, SV is determined as a function of the first derivative of the impedance waveform (dZ/dtmax) and the left ventricular ejection time (LVET)

$$SV = ρ \frac{{L}^{2}}{{Z}_{0}^{2}} {( \frac{d Z}{d t} )}_{max} LV ET$$

In one embodiment, L is approximated to be 17% of the patient's height (H) to yield the following:

$$SV = ( \frac{{( 0.17 H )}^{3}}{4.2} ) \frac{{( \frac{d Z}{d t} )}_{max}}{{Z}_{0}} LV ET$$

In another embodiment, or the actual weight divided by the ideal weight is used:

$$SV = δ \times ( \frac{{( 0.17 H )}^{3}}{4.2} ) \frac{{( \frac{d Z}{d t} )}_{max}}{{Z}_{0}} LV ET$$

The impedance cardiographic embodiment allows hemodynamic assessment to be regularly monitored to avoid the occurrence of an acute cardiac episode. The system provides an accurate, noninvasive measurement of cardiac output (CO) monitoring so that ill and surgical patients undergoing major operations such as coronary artery bypass graft (CABG) would benefit. In addition, many patients with chronic and comorbid diseases that ultimately lead to the need for major operations and other costly interventions might benefit from more routine monitoring of CO and its dependent parameters such as systemic vascular resistance (SVR).

Once SV has been determined, CO can be determined according to the following expression: CO=SV*HR, where HR=heart rate. The CO can be determined for every heart-beat. Thus, the system can determine SV and CO on a beat-to-beat basis.

In one embodiment to monitor heart failure, an array of BI sensors is place in proximity to the heart. The array of BI sensors detect the presence or absence, or rate of change, or body fluids proximal to the heart. The BI sensors can be supplemented by the EKG sensors. A normal, healthy, heart beats at a regular rate. Irregular heartbeats, known as cardiac arrhythmia, on the other hand, may characterize an unhealthy condition. Another unhealthy condition is known as congestive heart failure (“CHF”). CHF, also known as heart failure, is a condition where the heart has inadequate capacity to pump sufficient blood to meet metabolic demand. CHF may be caused by a variety of sources, including, coronary artery disease, myocardial infarction, high blood pressure, heart valve disease, cardiomyopathy, congenital heart disease, endocarditis, myocarditis, and others. Unhealthy heart conditions may be treated using a cardiac rhythm management (CRM) system. Examples of CRM systems, or pulse generator systems, include defibrillators (including implantable cardioverter defibrillator), pacemakers and other cardiac resynchronization devices.

In one implementation, BIA measurements can be made using an array of bipolar or tetra-polar electrodes that deliver a constant alternating current at 50 KHz frequency. Whole body measurements can be done using standard right-sided. The ability of any biological tissue to resist a constant electric current depends on the relative proportions of water and electrolytes it contains, and is called resistivity (in Ohms/cm 3). The measuring of bioimpedance to assess congestive heart failure employs the different bio-electric properties of blood and lung tissue to permit separate assessment of: (a) systemic venous congestion via a low frequency or direct current resistance measurement of the current path through the right ventricle, right atrium, superior vena cava, and sub-clavian vein, or by computing the real component of impedance at a high frequency, and (b) pulmonary congestion via a high frequency measurement of capacitive impedance of the lung. The resistance is impedance measured using direct current or alternating current (AC) which can flow through capacitors.

In one embodiment, a belt is worn by the patient with a plurality of BI probes positioned around the belt perimeter. The output of the tetra-polar probes is processed using a second-order Newton-Raphson method to estimate the left and right-lung resistivity values in the thoracic geometry. The locations of the electrodes are marked. During the measurements procedure, the belt is worn around the patient's thorax while sitting, and the reference electrode is attached to his waist. The data is collected during tidal respiration to minimize lung resistivity changes due to breathing, and lasts approximately one minute. The process is repeated periodically and the impedance trend is analyzed to detect CHF. Upon detection, the system provides vital parameters to a call center and the call center can refer to a physician for consultation or can call 911 for assistance.

In one embodiment, an array of noninvasive thoracic electrical bioimpedance monitoring probes can be used alone or in conjunction with other techniques such as impedance cardiography (ICG) for early comprehensive cardiovascular assessment and trending of acute trauma victims. This embodiment provides early, continuous cardiovascular assessment to help identify patients whose injuries were so severe that they were not likely to survive. This included severe blood and/or fluid volume deficits induced by trauma, which did not respond readily to expeditious volume resuscitation and vasopressor therapy. One exemplary system monitors cardiorespiratory variables that served as statistically significant measures of treatment outcomes: Qt, BP, pulse oximetry, and transcutaneous Po2 (Ptco2). A high Qt may not be sustainable in the presence of hypovolemia, acute anemia, pre-existing impaired cardiac function, acute myocardial injury, or coronary ischemia. Thus a fall in Ptco2 could also be interpreted as too high a metabolic demand for a patient's cardiovascular reserve. Too high a metabolic demand may compromise other critical organs. Acute lung injury from hypotension, blunt trauma, and massive fluid resuscitation can drastically reduce respiratory reserve.

One embodiment that measures thoracic impedance (resistive or reactive impedance associated with at least a portion of a thorax of a living organism). The thoracic impedance signal is influenced by the patient's thoracic intravascular fluid tension, heartbeat, and breathing (also referred to as “respiration” or “ventilation”). A “de” or “baseline” or “low frequency” component of the thoracic impedance signal (e.g., less than a cutoff value that is approximately between 0.1 Hz and 0.5 Hz, inclusive, such as, for example, a cutoff value of approximately 0.1 Hz) provides information about the subject patient's thoracic fluid tension, and is therefore influenced by intravascular fluid shifts to and away from the thorax. Higher frequency components of the thoracic impedance signal are influenced by the patient's breathing (e.g., approximately between 0.05 Hz and 2.0 Hz inclusive) and heartbeat (e.g., approximately between 0.5 Hz and 10 Hz inclusive). A low intravascular fluid tension in the thorax (“thoracic hypotension”) may result from changes in posture. For example, in a person who has been in a recumbent position for some time, approximately ⅓ of the blood volume is in the thorax. When that person then sits upright, approximately ⅓ of the blood that was in the thorax migrates to the lower body. This increases thoracic impedance. Approximately 90% of this fluid shift takes place within 2 to 3 minutes after the person sits upright.

The accelerometer can be used to provide reproducible measurements. Body activity will increase cardiac output and also change the amount of blood in the systemic venous system or lungs. Measurements of congestion may be most reproducible when body activity is at a minimum and the patient is at rest. The use of an accelerometer allows one to sense both body position and body activity. Comparative measurements over time may best be taken under reproducible conditions of body position and activity. Ideally, measurements for the upright position should be compared as among themselves. Likewise measurements in the supine, prone, left lateral decubitus and right lateral decubitus should be compared as among themselves. Other variables can be used to permit reproducible measurements, i.e. variations of the cardiac cycle and variations in the respiratory cycle. The ventricles are at their most compliant during diastole. The end of the diastolic period is marked by the QRS on the electrocardiographic means (EKG) for monitoring the cardiac cycle. The second variable is respiratory variation in impedance, which is used to monitor respiratory rate and volume. As the lungs fill with air during inspiration, impedance increases, and during expiration, impedance decreases. Impedance can be measured during expiration to minimize the effect of breathing on central systemic venous volume. While respiration and CHF both cause variations in impedance, the rates and magnitudes of the impedance variation are different enough to separate out the respiratory variations which have a frequency of about 8 to 60 cycles per minute and congestion changes which take at least several minutes to hours or even days to occur. Also, the magnitude of impedance change is likely to be much greater for congestive changes than for normal respiratory variation. Thus, the system can detect congestive heart failure (CHF) in early stages and alert a patient to prevent disabling and even lethal episodes of CHF. Early treatment can avert progression of the disorder to a dangerous stage.

In an embodiment to monitor wounds such as diabetic related wounds, the conductivity of a region of the patient with a wound or is susceptible to wound formation is monitored by the system. The system determines healing wounds if the impedance and reactance of the wound region increases as the skin region becomes dry. The system detects infected, open, interrupted healing, or draining wounds through lower regional electric impedances. In yet another embodiment, the bioimpedance sensor can be used to determine body fat. In one embodiment, the BI system determines Total Body Water (TBW) which is an estimate of total hydration level, including intracellular and extracellular water; Intracellular Water (ICW) which is an estimate of the water in active tissue and as a percent of a normal range (near 60% of TBW); Extracellular Water (ECW) which is water in tissues and plasma and as a percent of a normal range (near 40% of TBW); Body Cell Mass (BCM) which is an estimate of total pounds/kg of all active cells; Extracellular Tissue (ECT)/Extracellular Mass (ECM) which is an estimate of the mass of all other non-muscle inactive tissues including ligaments, bone and ECW; Fat Free Mass (FFM)/Lean Body Mass (LBM) which is an estimate of the entire mass that is not fat. It should be available in pounds/kg and may be presented as a percent with a normal range; Fat Mass (FM) which is an estimate of pounds/kg of body fat and percentage body fat; and Phase Angle (PA) which is associated with both nutrition and physical fitness.

Additional sensors such as thermocouples or thermisters and/or heat flux sensors can also be provided to provide measured values useful in analysis. In general, skin surface temperature will change with changes in blood flow in the vicinity of the skin surface of an organism. Such changes in blood flow can occur for a number of reasons, including thermal regulation, conservation of blood volume, and hormonal changes. In one implementation, skin surface measurements of temperature or heat flux are made in conjunction with hydration monitoring so that such changes in blood flow can be detected and appropriately treated.

In one embodiment, the patch includes a sound transducer such as a microphone or a piezoelectric transducer to pick up sound produced by bones or joints during movement. If bone surfaces are rough and poorly lubricated, as in an arthritic knee, they will move unevenly against each other, producing a high-frequency, scratching sound. The high-frequency sound from joints is picked up by wide-band acoustic sensor(s) or microphone(s) on a patient's body such as the knee. As the patient flexes and extends their knee, the sensors measure the sound frequency emitted by the knee and correlate the sound to monitor osteoarthritis, for example.

In another embodiment, the patch includes a Galvanic Skin Response (GSR) sensor. In this sensor, a small current is passed through one of the electrodes into the user's body such as the fingers and the CPU calculates how long it takes for a capacitor to fill up. The length of time the capacitor takes to fill up allows us to calculate the skin resistance: a short time means low resistance while a long time means high resistance. The GSR reflects sweat gland activity and changes in the sympathetic nervous system and measurement variables. Measured from the palm or fingertips, there are changes in the relative conductance of a small electrical current between the electrodes. The activity of the sweat glands in response to sympathetic nervous stimulation (Increased sympathetic activation) results in an increase in the level of conductance. Fear, anger, startle response, orienting response and sexual feelings are all among the emotions which may produce similar GSR responses.

In yet another embodiment, measurement of lung function such as peak expiratory flow readings is done though a sensor such as Wright's peak flow meter. In another embodiment, a respiratory estimator is provided that avoids the inconvenience of having the patient breathing through the flow sensor. In the respiratory estimator embodiment, heart period data from EKG/ECG is used to extract respiratory detection features. The heart period data is transformed into time-frequency distribution by applying a time-frequency transformation such as short-term Fourier transformation (STFT). Other possible methods are, for example, complex demodulation and wavelet transformation. Next, one or more respiratory detection features may be determined by setting up amplitude modulation of time-frequency plane, among others. The respiratory recognizer first generates a math model that correlates the respiratory detection features with the actual flow readings. The math model can be adaptive based on pre-determined data and on the combination of different features to provide a single estimate of the respiration. The estimator can be based on different mathematical functions, such as a curve fitting approach with linear or polynomical equations, and other types of neural network implementations, non-linear models, fuzzy systems, time series models, and other types of multivariate models capable of transferring and combining the information from several inputs into one estimate. Once the math model has been generated, the respirator estimator provides a real-time flow estimate by receiving EKG/ECG information and applying the information to the math model to compute the respiratory rate. Next, the computation of ventilation uses information on the tidal volume. An estimate of the tidal volume may be derived by utilizing different forms of information on the basis of the heart period signal. For example, the functional organization of the respiratory system has an impact in both respiratory period and tidal volume. Therefore, given the known relationships between the respiratory period and tidal volume during and transitions to different states, the information inherent in the heart period derived respiratory frequency may be used in providing values of tidal volume. In specific, the tidal volume contains inherent dynamics which may be, after modeling, applied to capture more closely the behavioral dynamics of the tidal volume. Moreover, it appears that the heart period signal, itself, is closely associated with tidal volume and may be therefore used to increase the reliability of deriving information on tidal volume. The accuracy of the tidal volume estimation may be further enhanced by using information on the subject's vital capacity (i.e., the maximal quantity of air that can be contained in the lungs during one breath). The information on vital capacity, as based on physiological measurement or on estimates derived from body measures such as height and weight, may be helpful in estimating tidal volume, since it is likely to reduce the effects of individual differences on the estimated tidal volume. Using information on the vital capacity, the mathematical model may first give values on the percentage of lung capacity in use, which may be then transformed to liters per breath. The optimizing of tidal volume estimation can be based on, for example, least squares or other type of fit between the features and actual tidal volume. The minute ventilation may be derived by multiplying respiratory rate (breaths/min) with tidal volume (liters/breath).

In another embodiment, inductive plethysmography can be used to measure a cross-sectional area of the body by determining the self-inductance of a flexible conductor closely encircling the area to be measured. Since the inductance of a substantially planar conductive loop is well known to vary as, inter alia, the cross-sectional area of the loop, an inductance measurement may be converted into a plethysmographic area determination. Varying loop inductance may be measured by techniques known in the art, such as, e.g., by connecting the loop as the inductance in a variable frequency LC oscillator, the frequency of the oscillator then varying with the cross-sectional area of the loop inductance varies. Oscillator frequency is converted into a digital value, which is then further processed to yield the physiological parameters of interest. Specifically, a flexible conductor measuring a cross-sectional area of the body is closely looped around the area of the body so that the inductance and the changes in inductance, being measured results from magnetic flux through the cross-sectional area being measured. The inductance thus depends directly on the cross-sectional area being measured, and not indirectly on an area which changes as a result of the factors changing the measured cross-sectional area. Various physiological parameters of medical and research interest may be extracted from repetitive measurements of the areas of various cross-sections of the body. For example, pulmonary function parameters, such as respiration volumes and rates and apneas and their types, may be determined from measurements of, at least, a chest transverse cross-sectional area and also an abdominal transverse cross-sectional area. Cardiac parameters, such central venous pressure, left and right ventricular volumes waveforms, and aortic and carotid artery pressure waveforms, may be extracted from repetitive measurements of transverse cross-sectional areas of the neck and of the chest passing through the heart. Timing measurements can be obtained from concurrent ECG measurements, and less preferably from the carotid pulse signal present in the neck. From the cardiac-related signals, indications of ischemia may be obtained independently of any ECG changes. Ventricular wall ischemia is known to result in paradoxical wall motion during ventricular contraction (the ischemic segment paradoxically “balloons” outward instead of normally contracting inward). Such paradoxical wall motion, and thus indications of cardiac ischemia, may be extracted from chest transverse cross-section area measurements. Left or right ventricular ischemia may be distinguished where paradoxical motion is seen predominantly in left or right ventricular waveforms, respectively. For another example, observations of the onset of contraction in the left and right ventricles separately may be of use in providing feedback to bi-ventricular cardiac pacing devices. For a further example, pulse oximetry determines hemoglobin saturation by measuring the changing infrared optical properties of a finger. This signal may be disambiguated and combined with pulmonary data to yield improved information concerning lung function.

In one embodiment to monitor and predict stroke attack, a cranial bioimpedance sensor is applied to detect fluids in the brain. The brain tissue can be modeled as an electrical circuit where cells with the lipid bilayer act as capacitors and the intra and extra cellular fluids act as resistors. The opposition to the flow of the electrical current through the cellular fluids is resistance. The system takes 50-kHz single-frequency bioimpedance measurements reflecting the electrical conductivity of brain tissue. The opposition to the flow of the current by the capacitance of lipid bilayer is reactance. In this embodiment, micro-amps of current at 50 kHz are applied to the electrode system. In one implementation, the electrode system consists of a pair of coaxial electrodes each of which has a current electrode and a voltage sensing electrode. For the measurement of cerebral bioimpedance, one pair of gel current electrodes is placed on closed eyelids and the second pair of voltage electrodes is placed in the sub-occipital region projecting towards the foramen magnum. The electrical current passes through the orbital fissures and brain tissue. The drop in voltage is detected by the sub-occipital electrodes and then calculated by the processor to bioimpedance values. The bioimpedance value is used to detect brain edema, which is defined as an increase in the water content of cerebral tissue which then leads to an increase in overall brain mass. Two types of brain edema are vasogenic or cytotoxic. Vasogenic edema is a result of increased capillary permeability. Cytotoxic edema reflects the increase of brain water due to an osmotic imbalance between plasma and the brain extracellular fluid. Cerebral edema in brain swelling contributes to the increase in intracranial pressure and an early detection leads to timely stroke intervention.

In another example, a cranial bioimpedance tomography system constructs brain impedance maps from surface measurements using nonlinear optimization. A nonlinear optimization technique utilizing known and stored constraint values permits reconstruction of a wide range of conductivity values in the tissue. In the nonlinear system, a Jacobian Matrix is renewed for a plurality of iterations. The Jacobian Matrix describes changes in surface voltage that result from changes in conductivity. The Jacobian Matrix stores information relating to the pattern and position of measuring electrodes, and the geometry and conductivity distributions of measurements resulting in a normal case and in an abnormal case. The nonlinear estimation determines the maximum voltage difference in the normal and abnormal cases.

In one embodiment, an electrode array sensor can include impedance, bio-potential, or electromagnetic field tomography imaging of cranial tissue. The electrode array sensor can be a geometric array of discrete electrodes having an equally-spaced geometry of multiple nodes that are capable of functioning as sense and reference electrodes. In a typical tomography application the electrodes are equally-spaced in a circular configuration. Alternatively, the electrodes can have non-equal spacing and/or can be in rectangular or other configurations in one circuit or multiple circuits. Electrodes can be configured in concentric layers too. Points of extension form multiple nodes that are capable of functioning as an electrical reference. Data from the multiple reference points can be collected to generate a spectrographic composite for monitoring over time.

The patient's brain cell generates an electromagnetic field of positive or negative polarity, typically in the millivolt range. The sensor measures the electromagnetic field by detecting the difference in potential between one or more test electrodes and a reference electrode. The bio-potential sensor uses signal conditioners or processors to condition the potential signal. In one example, the test electrode and reference electrode are coupled to a signal conditioner/processor that includes a low pass filter to remove undesired high frequency signal components. The electromagnetic field signal is typically a slowly varying DC voltage signal. The low pass filter removes undesired alternating current components arising from static discharge, electromagnetic interference, and other sources.

In one embodiment, the impedance sensor has an electrode structure with annular concentric circles including a central electrode, an intermediate electrode and an outer electrode, all of which are connected to the skin. One electrode is a common electrode and supplies a low frequency signal between this common electrode and another of the three electrodes. An amplifier converts the resulting current into a voltage between the common electrode and another of the three electrodes. A switch switches between a first circuit using the intermediate electrode as the common electrode and a second circuit that uses the outer electrode as a common electrode. The sensor selects depth by controlling the extension of the electric field in the vicinity of the measuring electrodes using the control electrode between the measuring electrodes. The control electrode is actively driven with the same frequency as the measuring electrodes to a signal level taken from one of the measuring electrodes but multiplied by a complex number with real and imaginary parts controlled to attain a desired depth penetration. The controlling field functions in the manner of a field effect transistor in which ionic and polarization effects act upon tissue in the manner of a semiconductor material.

With multiple groups of electrodes and a capability to measure at a plurality of depths, the system can perform tomo-graphic imaging or measurement, and/or object recognition. In one embodiment, a fast reconstruction technique is used to reduce computation load by utilizing prior information of normal and abnormal tissue conductivity characteristics to estimate tissue condition without requiring full computation of a non-linear inverse solution.

In another embodiment, the bioimpedance system can be used with electro-encephalograph (EEG) or ERP. Since this embodiment collects signals related to blood flow in the brain, collection can be concentrated in those regions of the brain surface corresponding to blood vessels of interest. A head cap with additional electrodes placed in proximity to regions of the brain surface fed by a blood vessel of interest, such as the medial cerebral artery enables targeted information from the regions of interest to be collected. The head cap can cover the region of the brain surface that is fed by the medial cerebral artery. Other embodiments of the head cap can concentrate electrodes on other regions of the brain surface, such as the region associated with the somato sensory motor cortex. In alternative embodiments, the head cap can cover the skull more completely. Further, such a head cap can include electrodes throughout the cap while concentrating electrodes in a region of interest. Depending upon the particular application, arrays of 1-16 head electrodes may be used, as compared to the International 10/20 system of 19-21 head electrodes generally used in an EEG instrument.

In one implementation, each amplifier for each EEG channel is a high quality analog amplifier device. Full bandwidth and ultra-low noise amplification are obtained for each electrode. Low pass, high pass, hum notch filters, gain, un-block, calibration and electrode impedance check facilities are included in each amplifier. All 8 channels in one EEG amplifier unit have the same filter, gain, etc. settings. Noise figures of less than 0.1 uV r.m.s. are achieved at the input and optical coupling stages. These figures, coupled with good isolation/common mode rejection result in signal clarity. Nine high pass filter ranges include 0.01 Hz for readiness potential measurement and 30 Hz for EMG measurement.

In one embodiment, stimulations to elicit EEG signals are used in two different modes, i.e., auditory clicks and electric pulses to the skin. The stimuli, although concurrent, are at different prime number frequencies to permit separation of different evoked potentials (EPs) and avoid interference. Such concurrent stimulations for EP permit a more rapid, and less costly, examination and provide the patient's responses more quickly. Power spectra of spontaneous EEG, wave shapes of Averaged Evoked Potentials, and extracted measures, such as frequency specific power ratios, can be transmitted to a remote receiver. The latencies of successive EP peaks of the patient may be compared to those of a normal group by use of a normative template. To test for ischemic stroke or intra-cerebral or subarachnoid hemorrhage, the system provides a blood oxygen saturation monitor, using an infra-red or laser source, to alert the user if the patient's blood in the brain or some brain region is deoxygenated.

A stimulus device may optionally be placed on each subject, such as an audio generator in the form of an ear plug, which produces a series of “click” sounds. The subject's brain waves are detected and converted into audio tones. The device may have an array of LED (Light Emitting Diodes) which blink depending on the power and frequency composition of the brain wave signal. Power ratios in the frequencies of audio or somato sensory stimuli are similarly encoded. The EEG can be transmitted to a remote physician or medical aide who is properly trained to determine whether the patient's brain function is abnormal and may evaluate the functional state of various levels of the patient's nervous system.

In another embodiment, three pairs of electrodes are attached to the head of the subject under examination via tape or by wearing a cap with electrodes embedded. In one embodiment, the electrode pairs are as follows:

1) Top of head to anterior throat

2) Inion-nasion

3) left to right mastoid (behind ear).

A ground electrode is located at an inactive site of the upper part of the vertebral column. The electrodes are connected to differential amplification devices as disclosed below. Because the electrical charges of the brain are so small (on the order of micro volts), amplification is needed. The three amplified analog signals are converted to digital signals and averaged over a certain number of successive digital values to eliminate erroneous values originated by noise on the analog signal.

All steps defined above are linked to a timing signal which is also responsible for generating stimuli to the subject. The responses are processed in a timed relation to the stimuli and averaged as the brain responds to these stimuli. Of special interest are the responses within certain time periods and time instances after the occurrence of a stimulus of interest. These time periods and instances and their references can be:

25 to 60 milliseconds: P1-N1

180 to 250 milliseconds: N2

100 milliseconds: N100

200 milliseconds: P2

300 milliseconds: P300.

In an examination two stimuli sets may be used in a manner that the brain has to respond to the two stimuli differently, one stimulus has a high probability of occurrence, and the other stimulus is a rare occurring phenomena. The rare response is the response of importance. Three response signals are sensed and joined into a three dimensional cartesian system by a mapping program. The assignments can be

nasion-inion=X,

left-right mastoid=Y, and

top of head to anterior throat=Z.

The assignment of the probes to the axes and the simultaneous sampling of the three response signals at the same rate and time relative to the stimuli allows to real-time map the electrical signal in a three dimensional space. The signal can be displayed in a perspective representation of the three dimensional space, or the three components of the vector are displayed by projecting the vector onto the three planes X-Y, Y-Z, and X-Z, and the three planes are inspected together or separately. Spatial information is preserved for reconstruction as a map. The Vector Amplitude (VA) measure provides information about how far from the center of the head the observed event is occurring; the center of the head being the center (0, 0, 0) of the coordinate system.

The cranial bioimpedance sensor can be applied singly or in combination with a cranial blood flow sensor, which can be optical, ultrasound, electromagnetic sensor(s) as described in more details below. In an ultrasound imaging implementation, the carotid artery is checked for plaque build-up. Atherosclerosis is systemic—meaning that if the carotid artery has plaque buildup, other important arteries, such as coronary and leg arteries, might also be atherosclerotic.

In another embodiment, an epicardial array monopolar ECG system converts signals into the multichannel spectrum domain and identifies decision variables from the autospectra. The system detects and localizes the epicardial projections of ischemic myocardial ECGs during the cardiac activation phase. This is done by transforming ECG signals from an epicardial or torso sensor array into the multichannel spectral domain and identifying any one or more of a plurality of decision variables. The ECG array data can be used to detect, localize and quantify reversible myocardial ischemia.

In yet another embodiment, a trans-cranial Doppler velocimetry sensor provides a non-invasive technique for measuring blood flow in the brain. An ultrasound beam from a transducer is directed through one of three natural acoustical windows in the skull to produce a waveform of blood flow in the arteries using Doppler sonography. The data collected to determine the blood flow may include values such as the pulse cycle, blood flow velocity, end diastolic velocity, peak systolic velocity, mean flow velocity, total volume of cerebral blood flow, flow acceleration, the mean blood pressure in an artery, and the pulsatility index, or impedance to flow through a vessel. From this data, the condition of an artery may be derived, those conditions including stenosis, vasoconstriction, irreversible stenosis, vasodilation, compensatory vasodilation, hyperemic vasodilation, vascular failure, compliance, breakthrough, and pseudo-normalization.

In addition to the above techniques to detect stroke attack, the system can detect numbness or weakness of the face, arm or leg, especially on one side of the body. The system detects sudden confusion, trouble speaking or understanding, sudden trouble seeing in one or both eyes, sudden trouble walking, dizziness, loss of balance or coordination, or sudden, severe headache with no known cause.

In one embodiment to detect heart attack, the system detects discomfort in the center of the chest that lasts more than a few minutes, or that goes away and comes back. Symptoms can include pain or discomfort in one or both arms, the back, neck, jaw or stomach. The system can also monitor for shortness of breath which may occur with or without chest discomfort. Other signs may include breaking out in a cold sweat, nausea or lightheadedness.

In order to best analyze a patient's risk of stroke, additional patient data is utilized by a stroke risk analyzer. This data may include personal data, such as date of birth, ethnic group, sex, physical activity level, and address. The data may further include clinical data such as a visit identification, height, weight, date of visit, age, blood pressure, pulse rate, respiration rate, and so forth. The data may further include data collected from blood work, such as the antinuclear antibody panel, B-vitamin deficiency, C-reactive protein value, calcium level, cholesterol levels, entidal CO.sub.2, fibromogin, amount of folic acid, glucose level, hematocrit percentage, H-pylori antibodies, hemocysteine level, hypercapnia, magnesium level, methyl maloric acid level, platelets count, potassium level, sedrate (ESR), serum osmolality, sodium level, zinc level, and so forth. The data may further include the health history data of the patient, including alcohol intake, autoimmune diseases, caffeine intake, carbohydrate intake, carotid artery disease, coronary disease, diabetes, drug abuse, fainting, glaucoma, head injury, hypertension, lupus, medications, smoking, stroke, family history of stroke, surgery history, for example.

In one embodiment, data driven analyzers may be used to track the patient's risk of stroke or heart attack. These data driven analyzers may incorporate a number of models such as parametric statistical models, non-parametric statistical models, clustering models, nearest neighbor models, regression methods, and engineered (artificial) neural networks. Prior to operation, data driven analyzers or models of the patient stoke patterns are built using one or more training sessions. The data used to build the analyzer or model in these sessions are typically referred to as training data. As data driven analyzers are developed by examining only training examples, the selection of the training data can significantly affect the accuracy and the learning speed of the data driven analyzer. One approach used heretofore generates a separate data set referred to as a test set for training purposes. The test set is used to avoid overfitting the model or analyzer to the training data. Overfitting refers to the situation where the analyzer has memorized the training data so well that it fails to fit or categorize unseen data. Typically, during the construction of the analyzer or model, the analyzer's performance is tested against the test set. The selection of the analyzer or model parameters is performed iteratively until the performance of the analyzer in classifying the test set reaches an optimal point. At this point, the training process is completed. An alternative to using an independent training and test set is to use a methodology called cross-validation. Cross-validation can be used to determine parameter values for a parametric analyzer or model for a non-parametric analyzer. In cross-validation, a single training data set is selected. Next, a number of different analyzers or models are built by presenting different parts of the training data as test sets to the analyzers in an iterative process. The parameter or model structure is then determined on the basis of the combined performance of all models or analyzers. Under the cross-validation approach, the analyzer or model is typically retrained with data using the determined optimal model structure.

In general, multiple dimensions of a user's EEG, EKG, BI, ultra sound, optical, acoustic, electromagnetic, or electrical parameters are encoded as distinct dimensions in a database. A predictive model, including time series models such as those employing autoregression analysis and other standard time series methods, dynamic Bayesian networks and Continuous Time Bayesian Networks, or temporal Bayesian-network representation and reasoning methodology, is built, and then the model, in conjunction with a specific query makes target inferences. Bayesian networks provide not only a graphical, easily interpretable alternative language for expressing background knowledge, but they also provide an inference mechanism; that is, the probability of arbitrary events can be calculated from the model. Intuitively, given a Bayesian network, the task of mining interesting unexpected patterns can be rephrased as discovering item sets in the data which are much more—or much less—frequent than the background knowledge suggests. These cases are provided to a learning and inference subsystem, which constructs a Bayesian network that is tailored for a target prediction. The Bayesian network is used to build a cumulative distribution over events of interest.

Further, in an embodiment, a genetic algorithm (GA) search technique can be used to find approximate solutions to identifying the user's stroke risks or heart attack risks. Genetic algorithms are a particular class of evolutionary algorithms that use techniques inspired by evolutionary biology such as inheritance, mutation, natural selection, and recombination (or crossover). Genetic algorithms are typically implemented as a computer simulation in which a population of abstract representations (called chromosomes) of candidate solutions (called individuals) to an optimization problem evolves toward better solutions. Traditionally, solutions are represented in binary as strings of 0s and 1s, but different encodings are also possible. The evolution starts from a population of completely random individuals and happens in generations. In each generation, the fitness of the whole population is evaluated, multiple individuals are stochastically selected from the current population (based on their fitness), modified (mutated or recombined) to form a new population, which becomes current in the next iteration of the algorithm.

Substantially any type of learning system or process may be employed to determine the stroke or heart attack patterns so that unusual events can be flagged.

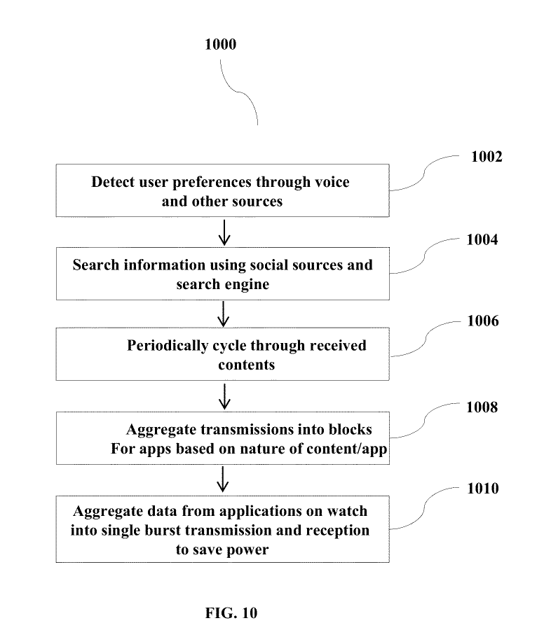

FIG. 9 is a flow chart illustrates generally, a method 900 for receiving and interacting with content using a watch, according to embodiments as disclosed herein. In an embodiment, at step 902, the method 900 includes accessing data wide area network through smart phone and low power transceiver. In an embodiment, at 904, the method 900 includes receive a plurality of multimedia contents through a wireless personal area network. The content described herein can include for example, but not limited to, real-time stock quotes, stock trading, weather updates, traffic alerts, sports scores, flight confirmation, news flashes, currency conversion, online yellow pages, games, mobile banking, mobile stock trading and other location-based, time-sensitive information, and the like. In an example, the method 900 includes receiving the plurality of contents through, for example, but not limited to, a broadcast directed to one or more devices, a direct connection, and a peer connection from another device. The broadcast device can be configured to broadcast a personal area network signal, an FM communication signal, a VHF communication signal, an UHF communication signal, a terrestrial broadcast communication signal, or a digital video broadcast (DVB) communication signal

In an embodiment, at step 906, the method 900 includes periodically cycle through received contents. Data can be pushed to the device or alternatively the device can pull its specific data needs from a server. The pull implementation can send a series of query requests to the server over the personal area network protocol. In an embodiment, at step 908, the method 900 includes aggregating data from applications on the watch into single burst transmission and reception to save power. The mobile device or server can be configured to aggregate the data from applications on the watch. Further, the method 900 includes receiving an input from a button on the watch indicating channel to be selected. In one embodiment, the system can receive a sports channel, a device skin (or device face) channel, a weather channel, a stocks channel, a news channel, a traffic channel, a movies channel, a secured channel, or a search channel. The device can receive an input from a button (such as a keypad, scrolling key, or an up/down button) on the device indicating the channel to be selected. The broadcast device or a server can be configured to receive input from the user to select content to be broadcast. The broadcast device can send a configuration message to the mobile electronic device indicating what watch faces to keep on the mobile electronic device. The user can select button from the watch to input the requested channel information.

In an embodiment, at step 910, the method 900 includes locating or searching for glanceable information using search engine. This can include local events for the day or week, for example. The method 900 can autonomously search information using a search engine by sending requests to the phone and searching using the Internet using cellular connections. The system can run a predetermined search query on a periodic basis and transmitting a search result over the search channel. The contents can be transmitted using Bluetooth protocol or alternatively through SMS protocol, Internet protocol, or encrypted protocol. The device periodically updates the contents with fresh information. In an embodiment, at step 912, the method 900 includes locating glanceable information from known sources, for example the wearable device can retrieve information from the user's favorite social network postings such as Facebook friend's postings, or can retrieve updates from LinkedIn profiles and provides glanceable information updates to the user. The automated search allows users to check traffic reports, sports events, weather forecasts, stock prices, news, movie listings and other information and receive messages. The device skin channel selection can include selecting a device face from the plurality of device faces. In an embodiment, at step 914, the method 900 includes retrieving glanceable information stored in the smart phone itself. For example, calendar information can be retrieved and displayed in a glanceable manner. The user authenticated and the information is encrypted prior to displaying secured channel content and displaying the content for a predetermined period on display, such as shown at 916. In an embodiment, the wearable device provides a display and input/output for a game program on the smart phone. For example, the game can be displayed on the wearable device and controlled via the input and output controls provided on the smart phone.

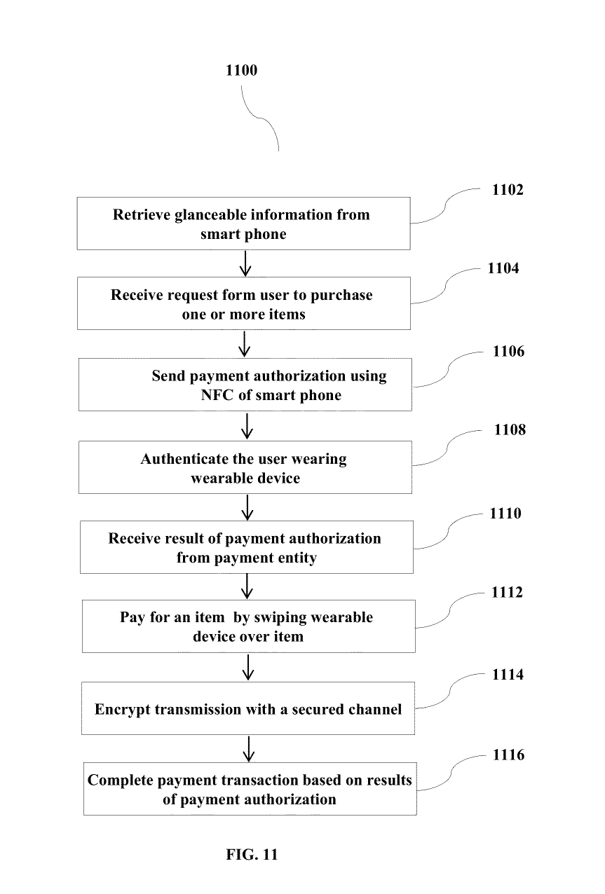

FIG. 10 is a flow chart illustrates generally, a method 1000 for receiving and interacting from various sources using a watch, according to embodiments as disclosed herein. In an embodiment, at step 1002, the method 1000 includes detecting user preferences through voice and other sources. In an example, if the user is communicating on phone with other users then the method 1000 includes using voice recognizing techniques to identify the user voice and detect the preferences such as user intent or and the like information. In an embodiment, at step 1004, the method 1000 includes search information using various social sources and search engine. The method 1000 allows the user to search information using the search engine. The user can search the search engine or communicated with other social sources (such as Facebook, LinkedIn, and the like social sites) using the user voice or text. The system can run a predetermined search query (including the user voice or text) on a periodic basis and transmitting a search result over the search channel. The contents can be transmitted using Bluetooth protocol or alternatively through SMS protocol, Internet protocol, or encrypted protocol. The device periodically updates the contents with fresh information.

In an embodiment, at 1006, the method 1000 includes periodically cycle through received contents. Data can be pushed to the device or alternatively the device can pull its specific data needs from a server. The pull implementation can send a series of query requests to the server over the personal area network protocol. In an embodiment, at 1008, the method 1000 includes dividing the data into different segments/bins based on the behavior/nature of content. For example, the applications can be divided into transmission time bins based on the behavior, such as to restrict the apps data look up during transmission period. The watch can be configured to first retrieve information related to all installed apps on the watch to determine the desired transmission time. In an embodiment, when a transmission request is received, the system can be configured to retrieve the data from the database based on the behavior of application. For example, for an email app information needs to be pulled for every 5 minutes so the email app can be segmented into a 5 min bin and consolidate the data request with other 5 min delayed apps. In another example, for a Twitter app the information requires constant Internet access, the system can segment the Twitter application in the 1 min bin, and perhaps News in a 1 hr update group and data can be aggregated accordingly.

In an embodiment, at step 1010, the method 1000 includes aggregating data from applications on the watch into single burst transmission and reception to save power. The mobile device or server can be configured to aggregate the curated content received from the various social sources and/or the applications on the watch. Further, the method includes receiving an input from a button on the watch indicating channel to be selected. In one embodiment, the system can receive a sports channel, a device skin (or device face) channel, a weather channel, a stocks channel, a news channel, a traffic channel, a movies channel, a secured channel, or a search channel. The device can receive an input from a button (such as a keypad, scrolling key, or an up/down button) on the device indicating the channel to be selected. The broadcast device or a server can be configured to receive input from the user to select content to be broadcast. The broadcast device can send a configuration message to the mobile electronic device indicating what watch faces to keep on the mobile electronic device. The user can select button from the watch to input the requested channel information.

FIG. 11 is a flow chart illustrates generally, a method 1100 for payment processing using Near-Field Communication (NFC) secure payment method, according to embodiments as disclosed herein. In an embodiment, at step 1102, the method 1100 includes retrieving glanceable information. The glanceable information can be retrieved from the smart phone itself or can be retrieved from the Internet. In an example, the meetings and appointment information can be retrieved and displayed in a glanceable manner. In another example, the wearable device can retrieve information from the user's favorite social network postings such as Facebook friend's postings, or can retrieve updates from LinkedIn profiles and provides glanceable information updates to the user. The automated search allows users to check traffic reports, sports events, weather forecasts, stock prices, news, movie listings and other information and receive messages.

In an embodiment, at step 1104, the method 1100 includes receiving a request to purchase one or more items from a user. The smart phone allows the user to select the one or more items and send a request to purchase the items. In general, the smart phone allows the user to perform any type of transaction that involves the exchange or transfer of funds, for e.g., the transaction can be a payment transaction, a fund transfer, or other type of transaction. In an embodiment, in response to receiving the request from the user, the method 1100 includes sending payment authorization using NFC of the smart phone, such as shown at step 1106. For example, the smart phone NFC can be used to authorize the purchase payment request received from the user. In an embodiment, at step 1108, the method 1100 includes authenticating the user wearing wearable device. In an example, if the other user is wearing a wearable device then the method 1100 includes authenticating the user. In an embodiment, at step 1110, the method 1100 includes receiving result of the payment authorization from a payment entity. The method 1100 allows the user to pay for the interested items by swiping the wearable device over the item.

In an embodiment, at step 1114, the method 1100 includes encrypting transmission of data with a secured channel. In an example, the user is authenticated and the information is encrypted prior to sending payment. For example, a near field communication (NFC) mobile terminal uses the baseband processor chip and NFC module NFC payment process, the use of hardware encryption chip previously written local encryption algorithm to encrypt the communication data between the baseband chip and NFC module. In an embodiment, the hardware encryption chip according to the local pre-encrypted information encrypted communication data is legitimate, which pre-encrypted information presets automatically fuse is unreadable. In an embodiment, at step 1116, the method 1100 completing payment transaction based on results of the payment authorization. The smart phone communicates the payment information to the user using the secured channel. In an example, the payment transaction can be completed based on the result of the payment authorization. If the payment transaction was authorized by the payment entity, then the sale of the items through the smart phone using the NFC is completed. Otherwise, if the payment transaction was not authorized by the payment entity, then the smart phone terminates the payment transaction.

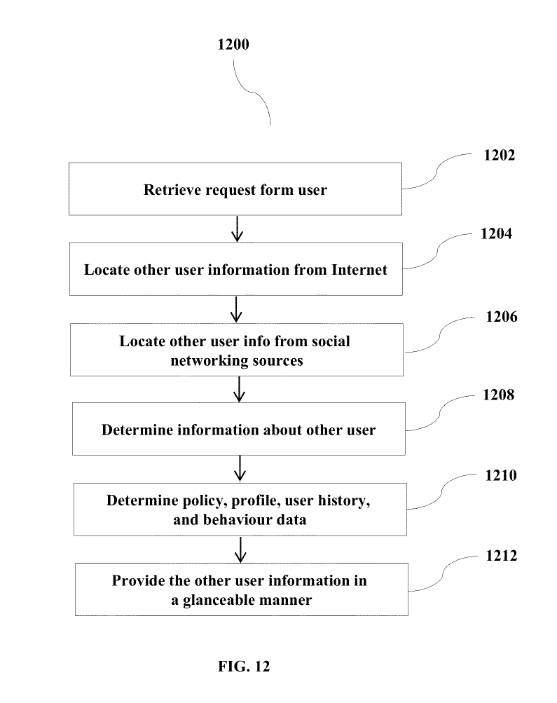

FIG. 12 is a flow chart illustrates generally, a method 1200 for presenting user information based on appointment data, according to embodiments as disclosed herein. In an embodiment, at step 1202, the method 1200 includes receiving a request from the user. For example, the user accesses the glanceable information or may provide a request to the smart phone to provide information about other user. In an embodiment, at step 1204, the method 1200 includes locating or searching for information related to the other user using Internet. This can include local events for the day or week, for example. The method 1200 can autonomously search information related to the other user using a search engine by sending requests to the phone and searching using the Internet using cellular connections. The system can search appointment information, local events, blogs, reviews, and the like sources over the internet to retrieve information related to the requested user. The system can run a predetermined search query on a periodic basis and transmitting a search result over the search channel. The contents can be transmitted using Bluetooth protocol or alternatively through SMS protocol, Internet protocol, or encrypted protocol.

In an embodiment, at step 1206, the method 1200 includes locating information related to the other user from social networking sources, for example the wearable device can retrieve information from the user's favorite social network postings such as Facebook friend's postings, from LinkedIn profiles, twitter, and the like social portals to retrieve information related to the requested user. The automated search allows users to check social networking post, community portals such as including information related to specific domain, groups related to a specific domain, conversations, appointment data, and the like to retrieve information related to the other user. In an embodiment, at step 1208, the method 1200 includes determining information related to the user. The method 1200 includes determining policy, profile, user history, and behavior data, and the like, such as to determine the information related to the other user as shown at step 1210. For example, the users may download or otherwise acquire the profile and other information from the social sources and Internet to determine the information related to the user. In an embodiment, at step 1208, the method 1200 includes providing the other user information in a glanceable manner. The user authenticated and the information is encrypted prior to displaying secured channel content and displaying the information related to the other user.

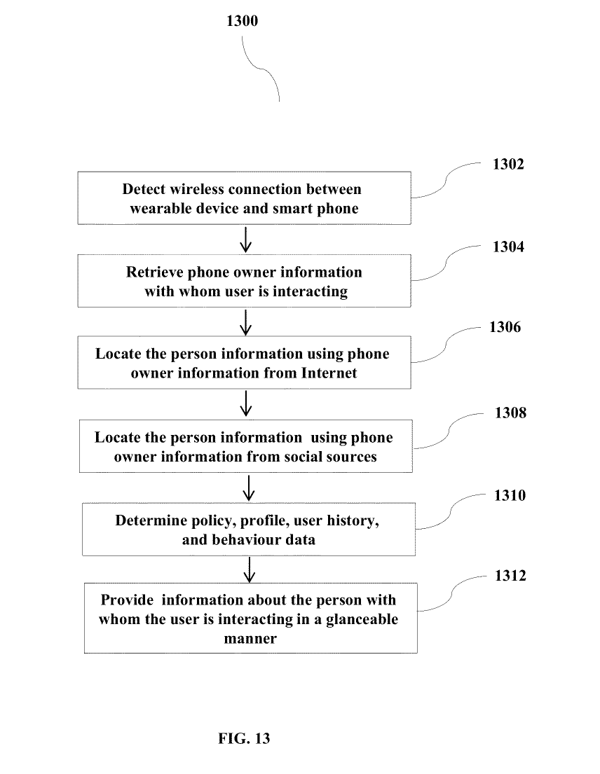

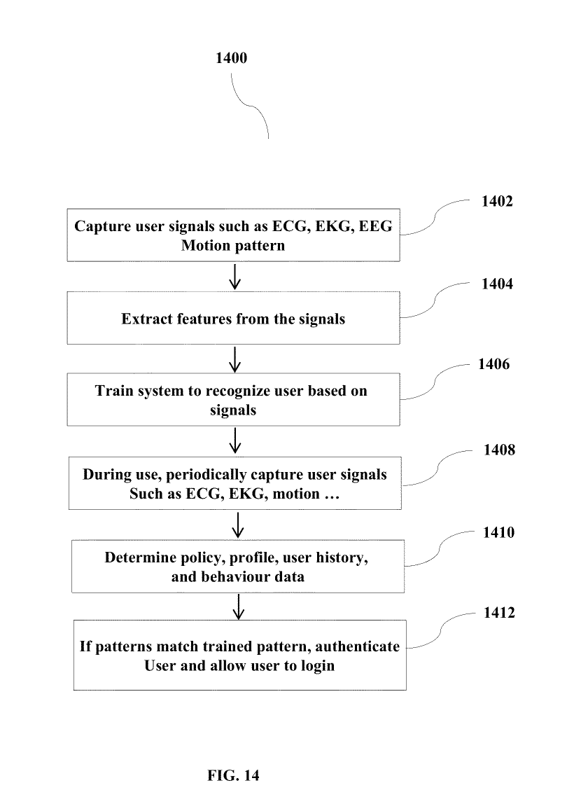

FIG. 13 is a flow chart illustrates generally, a method 1300 for automatically presenting information about person with whom the user is interacting, according to embodiments as disclosed herein. In an embodiment, at step 1302, the method 1300 includes detecting a wireless connection between the wearable device and the smart phone. The method 1300 allows the wearable device to detect the connection between the wearable device and the smart phone, and if the wireless connection fails, notifying a user to locate the smart phone. In an embodiment, at step 1304, the method 1300 includes receiving phone owner information with whom the user is interacting. Generally, when the user interacts with any person, then the wearable device is configured to detect the conversation and communicate with that person mobile phone to receive the owner information.

In an embodiment, at step 1306, the method 1300 includes locating or searching for the information related to the person using the Internet. The method 1200 can autonomously search information related to the other person using the owner information. A search engine can be used by sending requests including the owner information and searching using the Internet using cellular connections. The system can search appointment information, local events, blogs, reviews, and the like sources over the internet to retrieve information related to the person. The system can run a predetermined search query on a periodic basis and transmitting a search result over the search channel. The contents can be transmitted using Bluetooth protocol or alternatively through SMS protocol, Internet protocol, or encrypted protocol. In an embodiment, at step 1308, the method 1300 includes locating information related to the person from the social networking sources, for example the wearable device can retrieve information from the user's favorite social network postings such as Facebook friend's posting, LinkedIn, twitter, and the like to retrieve information related to the person using the phone owner information. The automated search allows the wearable device to check social networking post, community portals such as including information related to specific domain, groups related to a specific domain, conversations, appointment data, and the like to retrieve information related to the person. In an embodiment, at step 1310, the method 1300 includes determining information related to the person. The method 1300 includes determining policy, profile, user history, and behavior data, and the like, such as to determine the information related to the person. For example, the users may download or otherwise acquire the profile and other information from the social sources and Internet to determine the information related to the person. In an embodiment, at step 1312, the method 1300 includes providing the person information in a glanceable manner. The user authenticated and the information is encrypted prior to displaying secured channel content and displaying the information related to the person.

FIG. 14 shows an exemplary process to capture user biometrics for authenticating the user. The process starts by collecting user data such as ECG, EKG, EEG, motion patterns, activities of daily life, among others (1402). Next, features are extracted from the captured signals (1404). The captured data is used to train the system (1406). The recognizer can be a statistical recognizer such as Hidden Markov Model, or neural network, or fuzzy logic, or rule based recognizers. After training, the system can be used to authenticate the user. Of course, by simply wearing the device, the device ID can be used as a “key” that provides access to the phone or computer for security purposes. However, if the device is separated from the user, the user data such as EKG, ECG can be used to authenticate the user (1408). The system can determine access policy based on user profile, history and behavioral data (1410). If everything matches, the system can authenticate the user and allows login or other access to critical information or payment gateways, among others (1412).

In another embodiment, the system works with Intel Anti-Theft Technology (Intel AT) built into the processor of a laptop, so it is active as soon as the machine is switched on—even before startup. If the laptop is lost or stolen, a local or remote “poison pill” can be activated that renders the PC inoperable by blocking the boot process. This means that predators cannot hack into the system at startup. It works even without Internet access and, unlike many other solutions, is hardware-based, so it is tamper-resistant. Since it is built-in at the processor level, the IT administrator has a range of options to help secure mobile assets, such as:
Disable access to encrypted data by deleting essential elements of the cryptographic materials that are required to access the encrypted data on the hard drive.
Disable the PC using a “poison pill” to block the boot process, even if the boot order is changed or the hard drive is replaced or reformatted.
Customizable “Theft Mode” message allows the IT administrator to send a message to whoever starts up the laptop to notify them that it has been reported stolen.
Excessive login attempts trigger PC disable after an administrator-defined number of failed attempts. At this point, the AT trigger is tripped and the system locks itself down.
Failure to check in with the central server can trigger PC disable when a check-in time is missed. The IT administrator can set system check-in intervals. Upon a missed check-in time, the system is locked down until the user or IT administrator reactivates the system.
   The system turns the wearable watch or wrist band into a personal trusted device (PTD) having processing and storage capabilities allowing it to host and operate a data aggregation software application useful for managing and manipulating information. Devices falling within this definition may or may not include a display or keyboard, and include but are not limited to cell phones, wireless communication tablets, personal digital assistants, RF proximity chip cards, and laptop personal computers.

In yet another embodiment, the system uses a smart phone with a Near Field Communication transceiver and turns the device in to an electronic wallet. The system allows computer users to have exactly the same computing experience on any machine. The system enables users to store their personal computer settings on their mobile phone, and then transfer those settings to another computer with a flick of the wrist. The phone allows users to carry a lot of their desktop applications, settings and data in the flash drive, and load that data on to another computer. It will be as though the user is sitting at his own machine at home or work. When the user leaves, and the NFC-equipped phone is out of range, the host machine returns to its previous state. The system would essentially turn any computer in to the user's own, like the user is actually working on his computer; same settings, look, bookmarks, preferences. It would all be invisible. The phone would be all that is needed to unlock the computer.

The system turns the wrist watch into a personal trusted device (PTD) having processing and storage capabilities allowing it to host and operate a data aggregation software application useful for managing and manipulating information.

The system also converts the wrist watch in to an “e-wallet”, allowing owners to wave their phone over a contact pad in order to pay for items such as coffee, books or CDs in participating retailers. In accordance with embodiments of the present invention, a PTD may securely import information from a source utilizing encryption technology. The information to be imported is first encrypted. The encrypted information is then transmitted from a source to the PTD. The encrypted information is then stored by the PTD. Prior or subsequent to communication of the encrypted information, a decryption key is sent to the PTD user through a separate communication channel or utilizing a second device in order to establish a strong non-repudiation scheme. In accordance with one embodiment of the present invention, a PTD may securely import information from a source such as a magnetic stripe card or a second PTD utilizing an interface device. The interface device includes a receiver for receiving information from the source, and a short-range wireless transceiver such as an IR transceiver for communicating with the PTD. The interface device may also feature a cryptoprocessor including an embedded encryption key. Information communicated from the source to the interface device is encrypted with the key and then transmitted to the PTD in encrypted form. The user of the PTD may then decrypt the imported information using a corresponding decryption key communicated to the user through a separate channel. For example, the decryption key may be mailed to the home address of the PTD user as part of a periodic credit card billing statement.

The various actions, units, steps, blocks, or acts described herein can be performed in the order presented, in a different order, simultaneously, or a combination thereof. Further, in some embodiments, some of the actions, units, steps, blocks, or acts may be omitted, added, skipped, or modified without departing from the scope of the invention.

In an embodiment, an early version of recommender systems uses two approaches. The user-centric technique was based almost completely on past consumer purchases. This is not always the best way to predict future activity, particularly in product areas not related to the original sale.

The item-centric approach determines that many customers who bought one product also bought another and then recommended that all buyers of the first item also look at the second. This has proven to be fairly effective. On the other hand, many organizations interact with customers online, via fixed and mobile devices, and in physical stores. Each of these channels produces a stream of contextual information that recommendation engines cab use. Early systems were batch oriented and computed recommendations in advance for each customer, even before they revisited the e-commerce website. Thus, they could not always react to a customer's most recent behavior.

Recommendation engines work by trying to establish a statistical relationship between prospective customers and products or services they might be interested in buying. The systems establish these relationships via information about shoppers from e-commerce websites, call centers, or physical stores and about products. In some cases, systems that have detailed product information can make recommendations even without extensive customer data.

In an embodiment, the recommender systems collect data via APIs; transaction databases; or cookies, which can help with Web-log session (identifying browsing sessions from recorded clicks). New sources are becoming available through social networks, ad hoc and marketing networks, and other external sources. For example, data can be obtained from users' general browsing history accessed via tracking cookies, as well as non-purchasing activity on e-commerce sites and search engines. All this enables recommendation engines to take a more holistic view of the customer. Using greater amounts of data lets the engines find connections that might otherwise go unnoticed, which yields better suggestions. This also sometimes requires recommendation systems to use complex big-data analysis techniques. Online public profiles and preference listings on social networking sites such as Facebook add useful data.

Most recommendation engines use complex algorithms to translate user activities into suggested purchases that employ personalized collaborative filtering, which use multiple agents or data sources to identify patterns and draw conclusions. This approach helps determine that numerous users who have liked one type of product in the past may also like a second type in the future. Many systems use expert adaptive approaches. These techniques create new sets of suggestions, analyze their performance, and adjust the recommendation pattern for similar users. This lets systems adapt quickly to new trends and behaviors. Rules-based systems enable businesses to establish rules that optimize recommendation performance. For example, if a customer is looking for parts for a specific truck, rules would keep the system from offering parts for another vehicle.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The above specification, examples and data provide a complete description of the manufacture and use of the composition of the invention. Since many embodiments of the invention can be made without departing from the spirit and scope of the invention, the invention resides in the claims hereinafter appended.

1. A method for receiving and interacting with content using a wearable device and a smart phone, comprising:
accessing data a wide area network through the smart phone and a low power transceiver in the wearable device;
running one or more user installable applications on either the smart phone or the wearable device;
receiving a plurality of glanceable contents through the low power transceiver; and
periodically cycling through the received contents and displaying each content for a predetermined period on a display.

2. The method of claim 1, further comprising receiving one of: a sports channel, a device skin channel, a weather channel, a stocks channel, a news channel, a traffic channel, a movies channel, a secured channel, a search channel and advertiser channel.

3. The method of claim 2, wherein each channel is aggregated by the smart phone or server and transmitted to the wearable device in a group to save power consumption by the wearable device.

4. The method of claim 1, wherein the wearable device provides a display and input/output for a game program on the smart phone.

5. The method of claim 1, wherein the user queries the Internet using at least one of text and voice.

6. The method of claim 1, further comprising running a predetermined search query on a periodic basis and displaying the result to the user.

7. The method of claim 1, further comprising encrypting transmission with a secured channel when data comprises at least one of: a bank summary, a credit card summary, and a brokerage financial summary.

8. The method of claim 1, further comprising monitoring at least one of ECG, EKG, blood pulse, and motion pattern.

9. The method of claim 1, further comprising using the monitoring to authenticate a user or to login into the smart phone or a remote system.

10. The method of claim 1, further comprising aggregating data from applications on the watch into a single burst transmission or reception to save power.

11. The method of claim 1, further comprising displaying data from at least one social site when the user is meeting a person.

12. The method of claim 1, further comprising performing voice recognition on the smart phone and searching for information to display on the watch.

13. The method of claim 1, further comprising looking curated content received from at least one social sources and displaying information on the wearable device.

14. The method of claim 1, further comprising paying for an item by swiping the wearable device over the item.

15. The method of claim 1, further comprising detecting arm and wrist motion of the user to select a desired operation on the wearable device.

16. The method of claim 15, further comprising detecting the wrist and arm motion using the accelerometer and a human kinetic model.

17. The method of claim 15, further comprising turning on the display in response to detecting that the user is viewing the wearable device based on the a wrist and arm motion.

18. The method of claim 1, further comprising applying a human kinetic model to track health or calorie consumption.

19. The method of claim 1, further comprising applying a human kinetic model to control a user interface of the wearable device.

20. The method of claim 1, further comprising pushing a button during a conversation with a person to retrieve contents associated with the person, wherein the content is from the Internet or from a local computer file.

21. The method of claim 21, further comprising authenticating the person if the person is wearing a second wearable device and selectively sending content to the second wearable device.

22. The method of claim 1, further comprising sending payment to another person wearing a second wearable device.

23. The method of claim 1, wherein the wearable device includes a camera, comprising capturing an image of food and estimating calorie consumption.

24. The method of claim 1, comprising detecting a wireless connection between the wearable device and the smart phone and if the wireless connection fails, notifying a user to locate the smart phone.

25. A portable device, comprising
a wearable device including a wrist band or an eyeglass; and
a processor to execute code for
accessing data a wide area network through a smart phone and a low power transceiver in the wearable device;
running one or more user installable applications on either the smart phone or the wearable device;
receiving a plurality of glanceable contents through the low power transceiver; and
periodically cycling through the received contents and displaying each content for a predetermined period on a display.
